(19) United States
(12) Patent Application Publication
(10) Pub. No.: US 2019/0184958 A1
(43) Pub. Date: Jun. 20, 2019

(54) Brake Device and Method of Detecting Fluid Leakage in Brake Device

(71) Applicant: Hitachi Automotive Systems, Ltd., Hitachinaka-shi, lbaraki (JP)

(72) Inventors: Asahi WATANABE, Kawasaki-shi, Kanagawa (JP); Toshiya OOSAWA, Yokohama-shi, Kanagawa (JP)

(73) Assignee: Hitachi Automotive Systems, Ltd., Hitachinaka-shi, lbaraki (JP)

(21) Appl. No.: 16/311,451

(22) PCT Filed: Jun. 16, 2017
(86) PCT No.: PCT/JP2017/022241

§ 371 Date: Dec. 19, 2018

(30) Foreign Application Priority Data
Jul. 1, 2016 (JP) 2016-131823

(51) Int. Cl. B60T 17/22; B60T 8/17; B60T 13/14; B60T 13/68

(52) U.S. Cl. CPC B60T 17/221; B60T 8/17; B60T 2270/402; B60T 13/686; B60T 2270/406; B60T 13/142

(57) ABSTRACT

There are provided a brake device that enhances the detection accuracy of a system with fluid leakage, regardless of the degree of fluid leakage, and a fluid leakage detection method of the brake device. The brake device includes a hydraulic unit and a control unit. The control unit includes a hydraulic pressure controller configured to control operations of a primary system connection valve, a secondary system connection valve, and a hydraulic pressure source; a first fluid leakage detector configured to detect a fluid leakage of a brake fluid occurring in each system, based on a primary system hydraulic pressure and a secondary system hydraulic pressure, in a state that the hydraulic pressure source is driven by the hydraulic pressure controller and that the primary system connection valve and the secondary system connection valve are alternately opened and closed; and a second fluid leakage detector configured to detect a fluid leakage of the brake fluid occurring in each system, based on the primary system hydraulic pressure and the secondary system hydraulic pressure, in a state that the primary system connection valve and the secondary system connection valve are closed by the hydraulic pressure controller after execution of the fluid leakage detection by the first fluid leakage detector.

### TECHNICAL FIELD

The present invention relates to a brake device and a method of detecting fluid leakage in the brake device.

### BACKGROUND ART

In a known configuration of a brake device, two brake systems arranged to connect a master cylinder with respective wheel cylinders are connected with each other by a connecting fluid path, two connection valves are provided in the connecting fluid path, and a discharge side of a pump is connected with a position between the two connection valves. This brake device detects a system with fluid leakage, which has a fluid leakage defect of the wheel cylinder, out of the two systems, based on a differential pressure between the two systems when the pump is operated and the two connection valves are alternately opened and closed (refer to, for example, Patent Literature 1). Another known configuration detects a system with fluid leakage, based on a differential pressure between two systems after hydraulic pressures in the two systems are increased to a predetermined hydraulic pressure and two connection valves are subsequently closed (refer to, for example, Patent Literature 2).

### CITATION LIST

### Patent Literature

PTL 1: JP 2014-151806A

PTL 2: JP 2015-182631A

### SUMMARY OF INVENTION

### Technical Problem

However, in the former configuration out of the above prior art configurations, when the amount of leakage of the brake fluid is a relatively small amount, a differential pressure that is required for detection of the system with fluid leakage is not generated between the respective systems. When the amount of leakage of the brake fluid is a relatively large amount, on the other hand, the latter configuration fails to increase the hydraulic pressure in the system with fluid leakage to a predetermined hydraulic pressure and thereby fail to start fluid leakage detection.

One object of the present invention is to provide a brake device that enhances the detection accuracy of a system with fluid leakage, regardless of the degree of fluid of leakage, and a method of detecting fluid leakage in the brake device.

### Solution to Problem

A brake device according to one embodiment of the present invention detects a fluid leakage of a brake fluid occurring in each system, based on a primary system hydraulic pressure and a secondary system hydraulic pressure respectively detected by a primary system hydraulic pressure sensor and a secondary system hydraulic pressure sensor, in the state that a hydraulic pressure source is driven and that a primary system connection valve and a secondary system connection valve are alternately opened and closed. The brake device subsequently detects a fluid leakage of the brake fluid occurring in each system, based on the primary system hydraulic pressure and the secondary system hydraulic pressure respectively detected by the primary system hydraulic pressure sensor and the secondary system hydraulic pressure sensor, in the state that the primary system connection valve and the secondary system connection valve are closed.

The embodiment of the present invention improves the detection accuracy of the system with fluid leakage, regardless of the degree of fluid leakage.

### BRIEF DESCRIPTION OF DRAWINGS

FIG. 1 is a schematic configuration diagram illustrating a brake device 1 according to embodiment 1;

FIG. 2 is a flowchart showing state transition of respective control states;

FIG. 3 is a flowchart showing a processing flow in a fluid leakage detection mode according to embodiment 1;

FIG. 4 is a flowchart showing a flow of a first fluid leakage detection process;

FIG. 5 is a block diagram illustrating a hydraulic pressure feedback control;

FIG. 6 is a flowchart showing a flow of a second fluid leakage detection process;

FIG. 7 is a time chart showing operations of a hydraulic control unit 6 when only the first fluid leakage detection process is performed in the fluid leakage detection mode in the case of a relatively large amount of fluid leakage occurring in a P system;

FIG. 8 is a time chart showing operations of the hydraulic control unit 6 when only the first fluid leakage detection process is performed in the fluid leakage detection mode in the case of a relatively small amount of fluid leakage occurring in the P system;

FIG. 9 is a time chart showing operations of the hydraulic control unit 6 when only the second fluid leakage detection process is performed in the fluid leakage detection mode in the case of a relatively small amount of fluid leakage occurring in the P system;

FIG. 10 is a time chart showing operations of the hydraulic control unit 6 in the fluid leakage detection mode according to embodiment 1; and

FIG. 11 is a flowchart showing a processing flow in the fluid leakage detection mode according to embodiment 2.

### DESCRIPTION OF EMBODIMENTS

### Embodiment 1

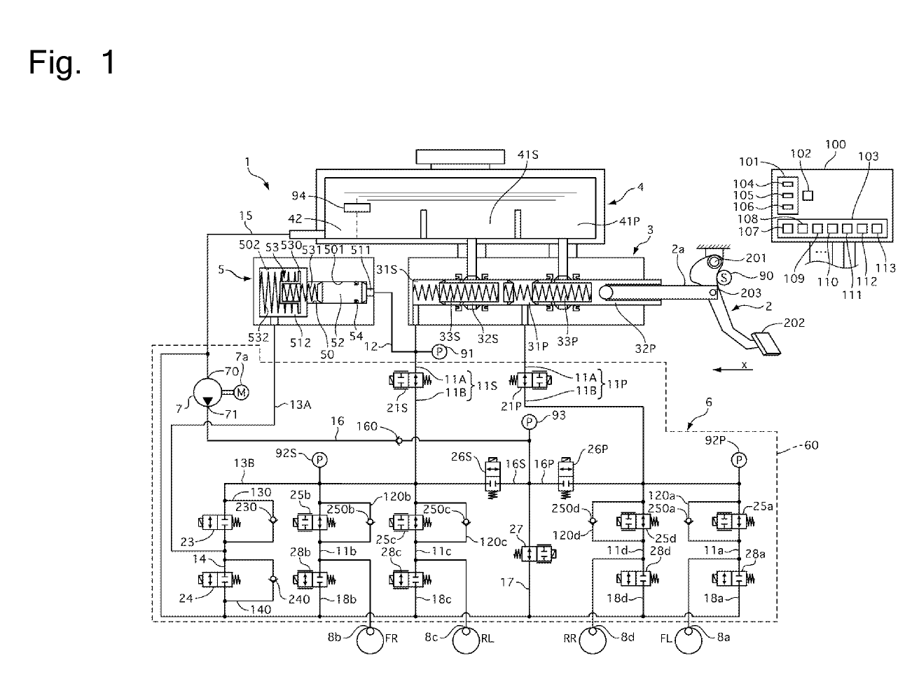

FIG. 1 is a schematic configuration diagram illustrating a brake device 1 according to embodiment 1. The brake device 1 (hereinafter referred to as device 1) is a hydraulic brake device suitable for an electrically-driven vehicle. The electrically-driven vehicle is, for example, a hybrid vehicle equipped with a motor generator (rotary electric machine) in addition to an engine (internal combustion engine) as a prime mover for driving wheels, or an electric vehicle equipped with only the motor generator. The device 1 may be applied to a vehicle having only an engine as a driving force source. The device 1 supplies a brake fluid to wheel cylinders 8 provided for respective wheels FL to RR of the vehicle to generate a brake hydraulic pressure (wheel cylinder hydraulic pressure Pw). A friction member is moved by this pressure Pw to be pressed against a wheel-side rotary member and thereby generates a frictional force. This applies a hydraulic braking force to the respective wheels FL to RR (left front wheel FL, right front wheel FR, left rear wheel RL and right rear wheel RR). The wheel cylinder 8 may be a cylinder of a hydraulic brake caliper in a disk brake mechanism or a wheel cylinder in a drum brake mechanism. The device 1 has two brake systems (brake pipes), i.e., P (primary) system and S (secondary) system, and employs, for example, an X piping layout. Another piping layout, for example, a longitudinal piping layout may be employed. In the description below, when a member provided for the P system and a member provided for the S system are to be distinguished from each other, P and S are suffixed to reference signs of the respective members.

A brake pedal 2 is a brake operation member configured to receive the driver's input of a brake operation. The brake pedal 2 is a so-called suspending type and has a base end that is rotatably supported by a shaft 201. A pad 202 as an object to be depressed by the driver is provided on a leading end of the brake pedal 2. One end of a push rod 2a is rotatably connected, by a shaft 203, to a base end side between the shaft 201 and the pad 202 of the brake pedal 2.

A master cylinder 3 is operated by the driver's operation of the brake pedal 2 (brake operation) to generate a brake hydraulic pressure (master cylinder hydraulic pressure Pm). The device 1 is not provided with a negative pressure-type booster that utilizes an intake negative pressure generated by an engine of the vehicle to boost or amplitude a brake operating force (pedal force F of the brake pedal 2). This configuration accordingly allows for downsizing of the device 1 and is optimum for the electrically-driven vehicle without a negative pressure source (in many cases, engine). The master cylinder 3 is connected to the brake pedal 2 via the push rod 2a and is configured to receive resupply of a brake fluid from a reservoir tank (reservoir) 4. The reservoir tank 4 is a brake fluid source which the brake fluid is stored in and is a low pressure portion open to the atmospheric pressure. A bottom side (lower side in a vertical direction) inside the reservoir tank 4 is parted by a plurality of partition members having predetermined heights into (to define) a primary hydraulic chamber space 41P, a secondary hydraulic chamber space 41S and a pump intake space 42. A fluid level sensor (fluid level detector) 94 is provided inside the reservoir tank to detect the level of the amount of the brake fluid in the reservoir tank. The fluid level sensor 94 is used to alarm the lowering of fluid level in the reservoir tank, includes a stationary member and a float member, and is configured to detect the fluid level in a discrete manner. The stationary member is fixed to an inner wall of the reservoir tank 4 and includes a switch. The switch is provided at a position that is approximately the same height as the fluid level. The float member is provided to float in the brake fluid and vertically move relative to the stationary member according to an increase or decrease in amount of the brake fluid (fluid level). When the amount of the brake fluid in the reservoir tank 4 decreases to move and lower the float member to a predetermined fluid level, the switch provided in the stationary member is switched over from an OFF state to an ON state. The fluid level sensor 94 accordingly detects the lowering of the fluid level. The fluid level sensor 94 is not specifically limited to the configuration of detecting the fluid level in a discrete manner (switch) but may be a configuration of continuously detecting the fluid level (analog detection).

The master cylinder 3 is a tandem type and includes a primary piston 32P and a secondary piston 32S that are arranged in series, as master cylinder pistons to move in an axial direction in response to a brake operation. The primary piston 32P is connected to the push rod 2a. The secondary piston 32S is a free piston.

The brake pedal 2 is provided with a stroke sensor 90. The stroke sensor 90 is configured to detect a displacement (pedal stroke S) of the brake pedal 2. The stroke sensor 90 may be provided on the push rod 2a or on the primary piston 32P to detect a piston stroke Sp. In this case, the pedal stroke S is equivalent to the product of a displacement (stroke) in the axial direction of the push rod 2a or the primary piston 32P and a pedal ratio K of the brake pedal. The pedal ratio K denotes a ratio of the pedal stroke S to the stroke of the primary piston 32P and is set to a predetermined value. For example, the pedal ratio K may be calculated from a ratio of a distance from the shaft 201 to the pad 202 to a distance from the shaft 201 to the shaft 203.

A stroke simulator 5 is operated in response to the driver's brake operation. The brake fluid flowing out from inside of the master cylinder 3 in response to the driver's brake operation flows into the stroke simulator 5, so that the stroke simulator 5 generates the pedal stroke S. A piston 52 of the stroke simulator 5 is moved in the axial direction in a cylinder 50 by the brake fluid supplied from the master cylinder 3. The stroke simulator 5 accordingly generates an operation reaction force accompanied by the driver's brake operation.

A hydraulic control unit (hydraulic unit) 6 is a braking control unit configured to generate a brake hydraulic pressure, independently of the driver's brake operation. An electronic control unit (hereinafter called ECU) 100 is a control unit configured to control the operations of the hydraulic control unit 6. The hydraulic control unit 6 receives the supply of the brake fluid from either the reservoir tank 4 or the master cylinder 3. The hydraulic control unit 6 is placed between the wheel cylinders 8 and the master cylinder 3 and is configured to individually supply the master cylinder hydraulic pressure Pm or the control hydraulic pressure to the respective wheel cylinders 8. The hydraulic control unit 6 includes a motor 7a of a pump (hydraulic pressure source) 7 and a plurality of control valves (solenoid valves 26 and the like), as hydraulic devices to generate the control hydraulic pressure. The pump 7 takes in the brake fluid from a brake fluid source other than the master cylinder 3 (for example, the reservoir tank 4) and discharges the brake fluid toward the wheel cylinders 8. For example, a plunger pump or a gear pump may be used for the pump 7. The pump 7 is commonly used in both the systems and is driven and rotated by the electric motor (rotary electric machine) 7a as an identical driving source. For example, a DC motor with brushes or a brushless motor may be used for the motor 7a. The solenoid valves 26 and the like are opened and closed in response to control signals to change over the connecting state of fluid paths 11 and the like. This controls the flow of the brake fluid. The hydraulic control unit 6 is provided to apply pressure to the wheel cylinders 8 by the hydraulic pressure generated by the pump 7 in the state that the master cylinder 3 is disconnected from the wheel cylinders 8. The hydraulic control unit 6 is provided with hydraulic pressure sensors 91 to 93 configured to detect the hydraulic pressure at respective positions, for example, a discharge pressure of the pump 7 and Pm.

Detection values sent from the stroke sensor 90 and from the hydraulic pressure sensors 91 to 93 and information regarding the driving state sent from the vehicle are input into the ECU 100. The ECU 100 performs information processing according to an internally stored program, based on these various pieces of information. The ECU 100 also outputs command signals to respective actuators of the hydraulic control unit 6 based on the results of processing to control these actuators. More specifically, the ECU 100 controls the open/close operations of the solenoid valves 26 and the like and the rotation speed of the motor 7a (in other words, the discharge of the pump 7). The ECU 100 accordingly controls the wheel cylinder hydraulic pressure Pw of the respective wheels FL to RR to implement various brake controls, for example, brake controls for boost control, antilock control, and vehicle motion control, automatic brake control, and regenerative cooperation brake control. The boost control generates a hydraulic braking force corresponding to an amount that is insufficient by the driver's brake operating force to assist the brake operation. The antilock control suppresses slip (lock tendency) of the wheels FL to RR by braking. The vehicle motion control is vehicle behavior stability control (hereinafter referred to as ESC) performed to prevent skid and the like. The automatic brake control is preceding vehicle following control and the like. The regenerative cooperation brake control controls the wheel cylinder hydraulic pressure Pw to achieve a target deceleration (target braking force), in cooperation with regenerative braking.

A primary hydraulic chamber (first chamber) 31P is defined between the respective pistons 32P and 32S of the master cylinder 3. A coil spring 33P is compressed to be placed in the primary hydraulic chamber 31P. A secondary hydraulic chamber (second chamber) 31S is defined between the piston 32S and an x-axis positive direction end of a cylinder 30. A coil spring 33S is compressed to be placed in the secondary hydraulic chamber 31S. First fluid paths 11 are open to the respective hydraulic chambers 31P and 31S. The respective hydraulic chambers 31P and 31S are connected to the hydraulic control unit 6 via the first fluid paths 11 and are provided to communicate with the wheel cylinders 8.

The piston 32 is stroked in response to the driver's pressing operation on the brake pedal 2, and the hydraulic pressure Pm is generated according to reduction of the volume of the hydraulic chamber 31. Approximately the same hydraulic pressure Pm is generated in the respective hydraulic chambers 31P and 31S. The brake fluid is accordingly supplied from the hydraulic chamber 31 through the first fluid path 11 to the wheel cylinders 8. The master cylinder 3 is configured to apply pressure to wheel cylinders 8a and 8d in the P system via a fluid path in the P system (first fluid path 11P) by the hydraulic pressure Pm generated in the primary hydraulic chamber 31P. The master cylinder 3 is also configured to apply pressure to wheel cylinders 8b and 8c in the S system via a fluid path in the S system (first fluid path 11S) by the hydraulic pressure Pm generated in the secondary hydraulic chamber 31S.

The following describes the configuration of the stroke simulator 5 with reference to FIG. 1. The stroke simulator 5 includes the cylinder 50, the piston 52 and a spring 53. FIG. 1 illustrates a cross section of the stroke simulator 5 passing through an axial center of the cylinder 50. The cylinder 50 is in a tubular form and has an inner circumferential surface in a cylindrical shape. The cylinder 50 includes a relatively small-diameter piston holder 501 on an x-axis negative direction side and a relatively large-diameter spring holder 502 on an x-axis positive direction side. A third fluid path 13 (13A) described later is normally open on an inner circumferential surface of the spring holder 502. The piston 52 is placed on an inner circumferential side of the piston holder 501 to be movable in the x-axis direction along an inner circumferential surface of the piston holder 501. The piston 52 is a separation member (partition wall) provided to separate inside of the cylinder 50 into at least two chambers (a positive pressure chamber 511 and a back pressure chamber 512). In the cylinder 50, the positive pressure chamber 511 is defined on an x-axis negative direction side of the piston 52, and the back pressure chamber 512 is defined on an x-axis positive direction side of the piston 52. The positive pressure chamber 511 is a space surrounded by an x-axis negative direction side face of the piston 52 and the inner circumferential surface of the cylinder 50 (the piston holder 501). A second fluid path 12 is normally open to the positive pressure chamber 511. The back pressure chamber 512 is a space surrounded by an x-axis positive direction side face of the piston 52 and the inner circumferential surface of the cylinder 50 (the spring holder 502 and the piston holder 501). A fluid path 13A is normally open to the back pressure chamber 512.

A piston seal 54 is placed on the outer circumference of the piston 52 to be extended around the axial center (in the circumferential direction) of the piston 52. The piston seal 54 is in sliding contract with the inner circumferential surface of the cylinder 50 (the piston holder 501) to seal between the inner circumferential surface of the piston holder 501 and an outer circumferential surface of the piston 52. The piston seal 54 is a separation seal member configured to seal between the positive pressure chamber 511 and the back pressure chamber 512 and thereby separate the positive pressure chamber 511 and the back pressure chamber 512 from each other fluid-tightly, and assists the function of the piston 52 as the separation member described above. The spring 53 is a coil spring that is compressed to be placed in the back pressure chamber 512, and normally presses the piston 52 in the x-axis negative direction. The spring 53 is provided to be deformable in the x-axis direction and is configured to generate a reaction force according to a displacement (stroke) of the piston 52. The spring 53 includes a first spring 531 and a second spring 532. The first spring 531 has a smaller diameter, a shorter length and a smaller wire diameter than the second spring 532. The first spring 531 has a smaller spring constant than the second spring 532. The first spring 531 and the second spring 532 are arranged in series via a retainer member 530 between the piston 52 and the cylinder 50 (the spring holder 502).

The following describes a hydraulic pressure circuit of the hydraulic control unit 6 with reference to FIG. 1. Members corresponding to the respective wheels FL to RR are appropriately distinguished from one another by adding suffixes a to d to the reference sign of the members. The first fluid path 11 is arranged to connect the hydraulic chamber 31 of the master cylinder 3 with the wheel cylinder 8. A shutoff valve 21 is a normally-open (open in the state of no electrical continuity) solenoid valve provided in the first fluid path 11. The first fluid path 11 is parted by the shutoff valve 21 into a fluid path 11A on the master cylinder 3-side and a fluid path 11B on the wheel cylinder 8-side. A solenoid-in valve (SOL/V IN) 25 is a normally open solenoid valve that is provided (in each of the fluid paths 11a to 11d) corresponding to each of the wheels FL to RR and is located on the wheel cylinder 8-side (in the fluid path 11B) of the shutoff valve 21 in the first fluid path 11. A bypass fluid path 120 provided in parallel with the first fluid path 11 to bypass the SOL/V IN 25. A check valve (one-way valve or no-return valve) 250 is provided in the bypass fluid path 120 to allow for only a flow of the brake fluid from the wheel cylinder 8-side toward the master cylinder 3-side.

An intake fluid path 15 is a fluid path that connects the reservoir tank 4 (the pump intake space 42) with an intake portion 70 of the pump 7. A discharge fluid path 16 connects a discharge portion 71 of the pump 7 with a position in the first fluid path 11B between the shutoff valve 21 and the SOL/V IN 25. A check valve 160 is provided in the discharge fluid path 16 to allow for only a flow of the brake fluid from the discharge portion 71-side of the pump 7 (upstream side) toward the first fluid path 11-side (downstream side). The check valve 160 is a discharge valve provided in the pump 7. The discharge fluid path 16 is branched off to a fluid path 16P in the P system and a fluid path 16S in the S system on the downstream side of the check valve 160. The fluid paths 16P and 16S are respectively connected to the first fluid path 11P in the P system and to the first fluid path 11S in the S system. The fluid paths 16P and 16S serve as connecting fluid paths to connect the first fluid paths 11P and 11S with each other. A connection valve 26P is a normally-closed (closed in the state of no electrical continuity) solenoid valve provided in the fluid path 16P. A connection valve 26S is a normally closed solenoid valve provided in the fluid path 16S. The pump 7 is a second hydraulic pressure source to generate the hydraulic pressure in the first fluid path 11 by the brake fluid supplied from the reservoir tank 4 and thereby generate the hydraulic pressure Pw in the wheel cylinders 8. The pump 7 is connected to the wheel cylinders 8a to 8d via the connecting fluid paths (discharge fluid paths 16P and 16S) and the first fluid paths 11P and 11S, and is configured to apply pressure to the wheel cylinders 8 by discharging the brake fluid to the connecting fluid paths (discharge fluid paths 16P and 16S).

A first pressure reducing fluid path 17 connects a position in the discharge fluid path 16 between the check valve 160 and the connection valve 26 with the intake fluid path 15. A pressure regulator 27 is a normally open solenoid valve serving as a first pressure reducing valve provided in the first pressure reducing fluid path 17. The pressure regulator 27 may be a normally-closed valve. A second pressure reducing fluid path 18 connects the wheel cylinder 8-side of the SOL/V IN 25 in the first fluid path 11B with the intake fluid path 15. A solenoid out valve (SO/V OUT) 28 is a normally closed solenoid valve serving as a second pressure reducing valve provided in the second pressure reducing fluid path 18. According to the embodiment, the first pressure reducing fluid path 17 on the intake fluid path 15-side of the pressure regulator 27 and the second pressure reducing fluid path 18 on the intake fluid path 15-side of the SOL/V OUT 28 are partly shared with each other.

A second fluid path 12 is a branch fluid path that is branched off from the first fluid path 11B and is connected to the stroke simulator 5. The second fluid path 12 serves, in combination with the first fluid path 11B, as a positive pressure-side fluid path connecting the secondary hydraulic chamber 31S of the master cylinder 3 with the positive pressure chamber 511 of the stroke simulator 5. The second fluid path 12 may directly connect the secondary hydraulic chamber 31S with the positive pressure chamber 511, instead of via the first fluid path 11A. A third fluid path 13 is a first back pressure-side fluid path connecting the back pressure chamber 512 of the stroke simulator 5 with the first fluid path 11. More specifically, the third fluid path 13 is branched off from a position in the first fluid path 11S (fluid path 11B) between the shutoff valve 21S and the SOL/V IN 25 and is connected to the back pressure chamber 512. A stroke simulator in-valve SS/V IN 23 is a normally closed solenoid valve provided in the third fluid path 13. The third fluid path 13 is parted by the SS/V IN 23 into a fluid path 13A on the back pressure chamber 512-side and a fluid path 13B on the first fluid path 11-side. A bypass fluid path 130 is provided in parallel with the third fluid path 13 to bypass the SS/V IN 23. The bypass fluid path 130 connects the fluid path 13A with the fluid path 13B. A check valve 230 is provided in the bypass fluid path 130. The check valve 230 allows for a flow of the brake fluid from the back pressure chamber 512-side (the fluid path 13A) toward the first fluid path 11-side (the fluid path 13B) and restrains a flow of the brake fluid in a reverse direction.

A fourth fluid path 14 is a second back pressure-side fluid path connecting the back pressure chamber 512 of the stroke simulator 5 with the reservoir tank 4. The fourth fluid path 14 connects a position in the third fluid path 13 (fluid path 13A) between the back pressure chamber 512 and the SS/V IN 23 with the intake fluid path 15 (or with the first pressure reducing fluid path 17 on the intake fluid path 15-side of the pressure regulator 27 and the second pressure reducing fluid path 18 on the intake fluid path 15-side of the SOL/V OUT 28). The fourth fluid path 14 may be directly connected to the back pressure chamber 512 and the reservoir tank 4. A stroke simulator out valve (simulator cut valve) SS/V OUT 24 is a normally closed solenoid valve provided in the fourth fluid path 14. A bypass fluid path 140 is provided in parallel with the fourth fluid path 14 to bypass the SS/V OUT 24. A check valve 240 is provided in the bypass fluid path 140 to allow for a flow of the brake fluid from the reservoir tank 4-side (the intake fluid path 15-side) toward the third fluid path 13A-side, i.e., toward the back pressure chamber 512-side and restrain a flow of the brake fluid in a reverse direction.

The shutoff valve 21, the SOL/V IN 25 and the pressure regulator 27 are proportional control valves configured such that the valve opening position is regulated according to the amount of electric current supplied to the solenoid. The other valves, i.e., the SS/V IN 23, the SS/V OUT 24, the connection valve 26 and the SOL/V OUT 28 are two-position valves (on/off valves) that are subjected to binary changeover control to be opened or to be closed. Proportional control valves may be employed for these other valves. A hydraulic pressure sensor 91 is provided at positions in the first fluid path 11S (in the fluid path 11A) between the shutoff valve 21S and the master cylinder 3 to detect the hydraulic pressure at this position (the master cylinder hydraulic pressure Pm and the hydraulic pressure in the positive pressure chamber 511 of the stroke simulator 5). Hydraulic pressure sensors 92 (primary system hydraulic pressure sensor 92P and secondary system hydraulic pressure sensor 92S) are provided at appositions in the first fluid path 11 between the shutoff valve 21 and the SOL/V IN 25 to detect the hydraulic pressure at these positions (wheel cylinder hydraulic pressure Pw). A hydraulic pressure sensor 93 is provided at a position in the discharge fluid path 16 between the discharge portion 71 of the pump 7 (check valve 160) and the connection valve 26 to detect the hydraulic pressure at this position (pump discharge pressure).

While the shutoff valve 21 is controlled in the valve-opening direction, the brake system (the first fluid path 11) that connects the hydraulic chamber 31 of the master cylinder 3 with the wheel cylinders 8 forms a first system. This first system generates the wheel cylinder hydraulic pressure Pw by the master cylinder hydraulic pressure Pm generated by using the pedal force F to achieve a pedal force brake (non-boost control). While the shutoff valve 21 is controlled in the valve-closing direction, on the other hand, the brake system (the intake fluid path 15, the discharge fluid path 16 and the like) that includes the pump 7 and that connects the reservoir tank 4 with the wheel cylinders 8 forms a second system. This second system configures a so-called brake-by-wire device that generates Pw by the hydraulic pressure generated by using the pump 7. The second system can achieve, for example, boost control as brake-by-wire control. At the time of brake-by-wire control (hereinafter simply called by-wire control), the stroke simulator 5 generates an operation reaction force accompanied with the driver's brake operation.

The ECU 100 includes a by-wire controller (hydraulic controller) 101, a pedal force brake portion 102 and a failsafe portion 103. The by-wire controller 101 closes the shutoff valve 21 and applies pressure to the wheel cylinders 8 by the pump 7 according to the driver's brake operation state. The by-wire controller 101 includes a brake operation state detector 104, a target wheel cylinder hydraulic pressure calculator 105, and a wheel cylinder hydraulic pressure controller 106.

The brake operation state detector 104 is configured to receive the input of a value detected by the stroke sensor 90 and detect the pedal stroke S as the driver's brake operation amount. The brake operation state detector 104 is also configured to determine whether it is during the driver's brake operation (whether there is an operation or no operation of the brake pedal 2), based on the pedal stroke S. A pedal force sensor may be provided to detect the pedal force F, and the brake operation amount may be detected or estimated, based on the detection value of the pedal force sensor. The brake operation amount may be detected or estimated, based on the detection value of the hydraulic pressure sensor 91. Accordingly, the brake operation amount used for the control is not limited to S but may be another appropriate variable.

The target wheel cylinder hydraulic pressure calculator 105 calculates a target wheel cylinder hydraulic pressure Pw*. For example, in the process of boost control, Pw* that achieves an ideal relationship (brake characteristic) between the pedal stroke S and the driver's required brake hydraulic pressure (the driver's required vehicle deceleration) at a predetermined boost ratio, based on the detected pedal stroke S (brake operation amount). For example, in a brake device equipped with a normal size negative pressure-type booster, a predetermined relationship between S and Pw (braking force) provided during the operation of the negative pressure-type booster is set as the ideal relationship used to calculate Pw*.

The wheel cylinder hydraulic pressure controller 106 controls the shutoff valve 21 in the valve-closing direction to cause the hydraulic control unit 6 to fall into a state that Pw can be generated by the pump 7 (second system) (pressurization control). In this state, the wheel cylinder hydraulic pressure controller 106 performs hydraulic control (for example, boost control) that controls the respective actuators of the hydraulic control unit 6 to provide Pw*. More specifically, the wheel cylinder hydraulic pressure controller 106 controls the shutoff valve 21 in the valve-closing direction, controls the connection valve 26 in the valve-opening direction, controls the pressure regulator 27 in the valve-closing direction, and operates the pump 7. Such control enables the desired brake fluid to be fed from the reservoir tank 4-side through the intake fluid path 15, the pump 7, the discharge fluid path 16 and the first fluid path 11 to the wheel cylinders 8. The brake fluid discharged by the pump 7 flows through the discharge fluid path 16 into the first fluid path 11B. The inflow of this brake fluid into the respective wheel cylinders 8 applies pressure to the respective wheel cylinders 8. More specifically, this applies pressure to the wheel cylinders 8 by using the hydraulic pressure generated in the first fluid path 11B by the pump 7. A desired braking force may be obtained by feedback control of the rotation speed of the pump 7 and the valve-opening state (opening position and the like) of the pressure regulator 27 such that the detection value of the hydraulic pressure sensor 92 approaches Pw*. More specifically, Pw may be regulated by control of the valve-opening state of the pressure regulator 27 and by appropriate leakage of the brake fluid from the discharge fluid path 16 or the first fluid path 11 to the intake fluid path 15 via the pressure regulator 27. According to the embodiment, Pw is controlled basically not by changing the rotation speed of the pump 7 (motor 7a) but by changing the valve-opening state of the pressure regulator 27. Controlling the shutoff valve 21 in the valve-closing direction to isolate the master cylinder 3-side from the wheel cylinders 8-side facilitates control of Pw independently of the driver's brake operation. The SS/V OUT 24 is controlled in the valve-opening direction. This causes the back pressure chamber 512 of the stroke simulator 5 to communicate with the intake fluid path 15-side (reservoir tank 4-side). The brake fluid is accordingly discharged from the master cylinder 3, in response to the pressing operation on the brake pedal 2. This brake fluid flows into the positive pressure chamber 511 of the stroke simulator 5 to operate the piston 52. This generates the pedal stroke Sp. An equivalent amount of the brake fluid to the amount of the fluid flowing into the positive pressure chamber 511 flows out from the back pressure chamber 512. This brake fluid is discharged to the intake fluid path 15-side (reservoir tank 4-side) through the third fluid path 13A and the fourth fluid path 14. The fourth fluid path 14 needs to be connected to a low pressure portion that allows the brake fluid to flow in but may not be necessarily connected to the reservoir tank 4. An operation reaction force (pedal reaction force) that is applied to the brake pedal 2 is generated by the force of pressing the piston 52 by the spring 53 of the stroke simulator 5, the hydraulic pressure in the back pressure chamber 512 and the like. Accordingly, the stroke simulator 5 provides the characteristic of the brake pedal 2 (F-S characteristic showing the relationship of S to F) during the by-wire control.

The pedal force brake portion 102 opens the shutoff valve 21 and causes the master cylinder 3 to apply pressure to the wheel cylinders 8. Controlling the shutoff valve 21 in the valve-opening direction causes the hydraulic control unit 6 to fall into such a state that enables the wheel cylinder hydraulic pressure Pw to be generated by the master cylinder hydraulic pressure Pm (first system), thus providing the pedal force brake. In this state, controlling the SS/V OUT 24 in the valve-closing direction causes the stroke simulator 5 not to operate irrespective of the driver's brake operation. This causes the brake fluid to be efficiently supplied from the master cylinder 3 to the wheel cylinders 8. This accordingly suppresses reduction of Pw generated by the driver's pedal force F. More specifically, the pedal force brake portion 102 causes all the actuators in the hydraulic control unit 6 not to operate. The SS/V IN 23 may be controlled in the valve-opening direction.

The failsafe portion 103 is configured to detect the occurrence of an abnormality (defect or failure) in the device 1. For example, the failsafe portion 103 detects a defect of the actuator (for example, the pump 7, the motor 7a, and the pressure regulator 27) in the hydraulic control unit 6, based on a signal from the brake operation state detector 104 and signals from the respective sensors. The failsafe portion 103 also detects an abnormality of a vehicle-mounted power source configured to provide power supply to the device 1 or an abnormality of the ECU 100. When detecting the occurrence of an abnormality during by-wire control, the failsafe portion 103 changes over the control according to the state of the abnormality. For example, when it is determined that the hydraulic control by the by-wire control is not continuable, the failsafe portion 103 operates the pedal force brake portion 102 to change over the control from the by-wire control to the pedal force brake. More specifically, the failsafe portion 103 causes all the actuators in the hydraulic control unit 6 not to operate and shifts the control to the pedal force brake. The shutoff valve 21 is a normally open valve. In the case of a defect of power supply, opening the shutoff valve 21 automatically provides the pedal force brake. The SS/V OUT 24 is a normally closed valve. Accordingly, in the case of a defect of power supply, closing the SS/V OUT 24 automatically causes the stroke simulator 5 not to operate. The connection valve 26 is a normally closed valve. Accordingly, in the case of a defect of power supply, the brake hydraulic pressure systems in the respective systems are made independent of each other to separately apply pressure to the wheel cylinders by the pedal force F in the respective systems.

When the fluid level sensor 94 detects lowering of the fluid level in the reservoir tank, the failsafe portion 103 operates to detect the brake system having a fluid leakage defect of the wheel cylinder 8 (system with fluid leakage) out of the two brake systems. When failsafe portion 103 detects the system with fluid leakage, the by-wire controller 101 performs the by-wire control with only the brake system without a fluid leakage defect (normal system) (this is called single-system boost control). The single-system boost control closes the connection valve 26 in the system with fluid leakage to block the connecting fluid path in the system with fluid leakage, while operating the shutoff valve 21, the pressure regulator 27 and the pump 7 in the same manner as the ordinary control (ordinary by-wire control). This controls the wheel cylinder hydraulic pressure Pw in the normal system.

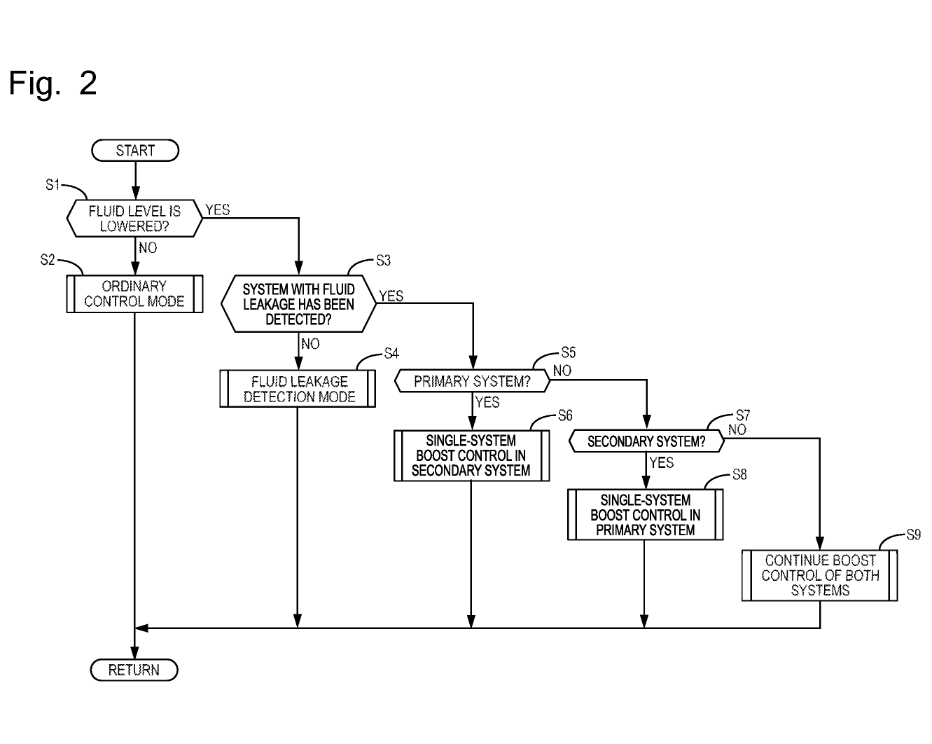

FIG. 2 is a flowchart showing state transition of the respective control states. This process is implemented in the form of a program in the ECU 100 and is performed at predetermined cycles.

At step S1, the failsafe portion 103 determines whether the fluid level of the brake fluid stored in the reservoir tank 4 is lowered, based on the signal from the fluid level sensor 94. In the case of YES, the flow proceeds to step S3. In the case of NO, the flow proceeds to step S2.

At step S2, the by-wire controller 101 performs an ordinary control mode. The ordinary control mode denotes a mode in which the by-wire controller 101 performs ordinary by-wire control.

At step S3, the failsafe portion 103 determines whether the system with fluid leakage has been detected. In the case of YES, the flow proceeds to step S5. In the case of NO, the flow proceeds to step S4.

At step S4, the failsafe portion 103 performs a fluid leakage detection mode. The fluid leakage detection mode denotes a mode in which the system with fluid leakage is detected. The details of the fluid leakage detection mode will be described later.

At step S5, the failsafe portion 103 determines whether the system with fluid leakage is the P system. In the case of YES, the flow proceeds to step S6. In the case of NO, the flow proceeds to step S7.

At step S6, the by-wire controller 101 performs a single-system boost mode in the S system. The single-system boost mode in the S system denotes a mode in which the by-wire controller 101 performs the by-wire control in only the S system. In the case of detection of a fluid leakage defect in the P system, the single-system boost control is performed in the normal S system.

At step S7, the failsafe portion 103 determines whether the system with fluid leakage is the S system. In the case of YES, the flow proceeds to step S8. In the case of NO, the flow proceeds to step S9.

At step S8, the by-wire controller 101 performs a single-system boost mode in the P system. The single-system boost mode in the P system denotes a mode in which the by-wire controller 101 performs the by-wire control in only the P system. In the case of detection of a fluid leakage defect in the S system, the single-system boost control is performed in the normal P system.

At step S9, the by-wire controller 101 continues the boost control in both the P and S systems. For example, even in the case of no fluid leakage occurring in the wheel cylinder 8, when the brake fluid is not replenished for a long time period in spite of wear of a brake pad and an increase in fluid amount consumed in the wheel cylinder 8 compared with the fluid amount consumed prior to the wear, the fluid level in the reservoir tank 4 is lowered. In the case of a fluid leakage on the master cylinder side (fluid path 11A) of the shutoff valve 21 in the first fluid path 11, the fluid level in the reservoir tank 4 is lowered. In these cases, the boost control is continuable. Because of a decrease in the usable amount of the brake fluid, however, it is preferable to perform minimum boost control for stably decelerating the vehicle, prohibit the brake control for vehicle motion control and the automatic brake control, and urge the driver to perform maintenance.

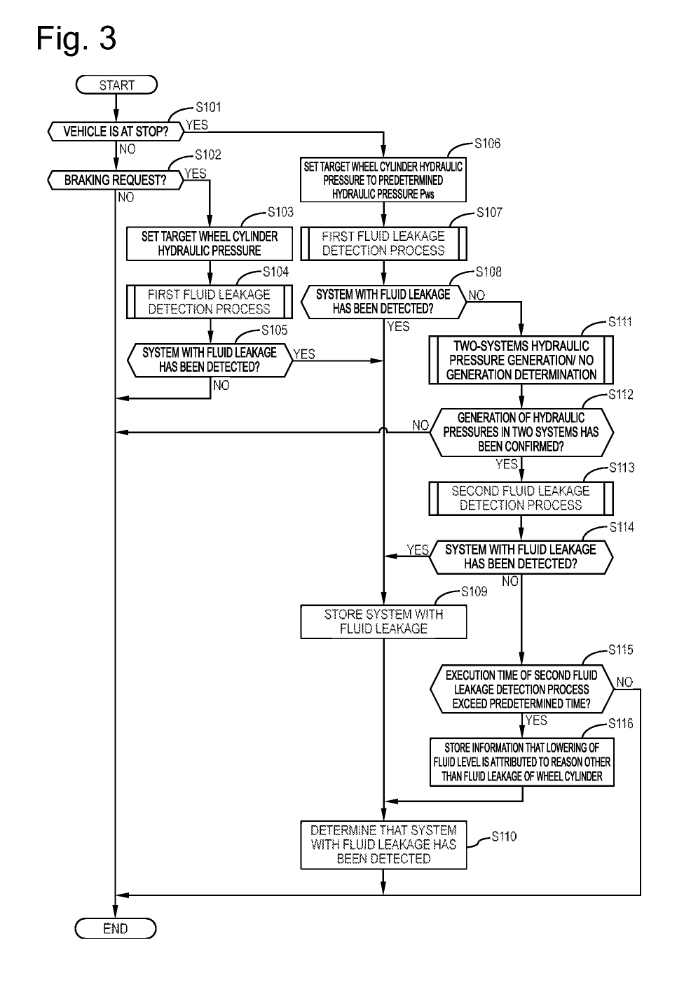

FIG. 3 is a flowchart showing a processing flow in the fluid leakage detection mode according to embodiment 1. The failsafe portion 103 of the ECU 100 includes, as the configuration for performing the fluid leakage detection mode, a first fluid leakage detector 107, a second fluid leakage detector 108, a two-systems hydraulic pressure generation/non-generation determiner 109, a vehicle drive/stop state determiner 110, a second fluid leakage detection execution time determiner 111, and a vehicle braking request determiner 112.

At step S101, the vehicle drive/stop state determiner 110 determines whether the vehicle is at stop. In the case of YES, the flow proceeds to step S106. In the case of NO, the flow proceeds to step S102. This step obtains the input of signals of respective wheel speed sensors mounted on the vehicle with regard to the respective wheels FL to RL and determines that the vehicle is at stop when all the wheel speeds are equal to zero (or approximately equal to zero). Step S101 is the vehicle drive/stop state determination step.

At step S102, the vehicle braking request determiner 112 determines whether there is a braking request. In the case of YES, the flow proceeds to step S103. In the case of NO, the flow terminates the processing. This step determines whether there is a braking request for the vehicle, based on information from the brake operation state detector 104 or from the target wheel cylinder hydraulic pressure calculator 105. For example, when S is other than zero, this indicates that the driver depresses the brake pedal 2. Accordingly, it is determined that there is a braking request. Step S102 is the vehicle braking request determination step.

At step S103, the target wheel cylinder hydraulic pressure Pw* is set, based on information from the target wheel cylinder hydraulic pressure calculator 105.

At step S104, the first fluid leakage detector 107 performs a first fluid leakage detection process. The details of the first fluid leakage detection process will be described later. Step S104 is the first fluid leakage detection step.

At step S105, the failsafe portion 103 determines whether the system with fluid leakage has been detected. In the case of YES, the flow proceeds to step S109. In the case of NO, the flow terminates the processing.

At step S106, the failsafe portion 103 sets the target wheel cylinder hydraulic pressure Pw* to a predetermined hydraulic pressure Pws for detection of fluid leakage at vehicle stop. PWs is the hydraulic pressure higher than the target wheel cylinder hydraulic pressure Pw* calculated by the target wheel cylinder hydraulic pressure calculator 105. This increases the outflow rate in the case of fluid leakage and enhances the detection performance.

At step S107, the first fluid leakage detector 107 performs the first fluid leakage detection process. Step S107 is the first fluid leakage detection step.

At step S108, the failsafe portion 103 determines whether the system with fluid leakage has been detected. In the case of YES, the flow proceeds to step S9. In the case of NO, the flow proceeds to step S111.

At step S109, the failsafe portion 103 stores the system with fluid leakage. At step S110, the failsafe portion 103 determines that the system with fluid leakage has been detected and terminates the processing.

At step S111, the two-systems hydraulic pressure generation/non-generation determiner 109 checks whether the hydraulic pressures have been generated in both the P system and the S system. The generation of the hydraulic pressure can be checked by determining whether the hydraulic pressures in both the P system and the S system are approximately equal to the predetermined hydraulic pressure Pws for detection of fluid leakage at vehicle stop (differential pressures is small). It is preferable that continuation of the state of small differential pressures for a predetermined time is employed as the condition of this check. Step S111 is the two-systems hydraulic pressure generation/non-generation determination step.

At step S112, the failsafe portion 103 determines whether generation of the hydraulic pressures has been confirmed in both the P system and the S system. In the case of YES, the flow proceeds to step S113. In the case of NO, the flow terminates the processing.

At step S113, the second fluid leakage detector 108 performs a second fluid leakage detection process. The details of the second fluid leakage detection process will be described later. Step S113 is the second fluid leakage detection step.

At step S114, the failsafe portion 103 determines whether the system with fluid leakage has been detected. In the case of YES, the flow proceeds to step S109. In the case of NO, the flow proceeds to step S115.

At step S115, the second fluid leakage detection execution time determiner 111 determines whether an execution time of the second fluid leakage detection process by the second fluid leakage detector 108 exceeds a predetermined time. In the case of YES, the flow proceeds to step S116. In the case of NO, the flow terminates the processing. Step S115 is the second fluid leakage detection execution time determination step.

At step S116, the failsafe portion 103 determines that lowering of the fluid level in the reservoir tank 4 is attributed to a reason other than the fluid leakage defect of the wheel cylinder 8 and stores information regarding such determination. When the execution time of the second fluid leakage detection process exceeds the predetermined time, this indicates the case of no fluid leakage of the wheel cylinder 8 that is an object to be detected by this processing. The fluid leakage detection mode is accordingly terminated.

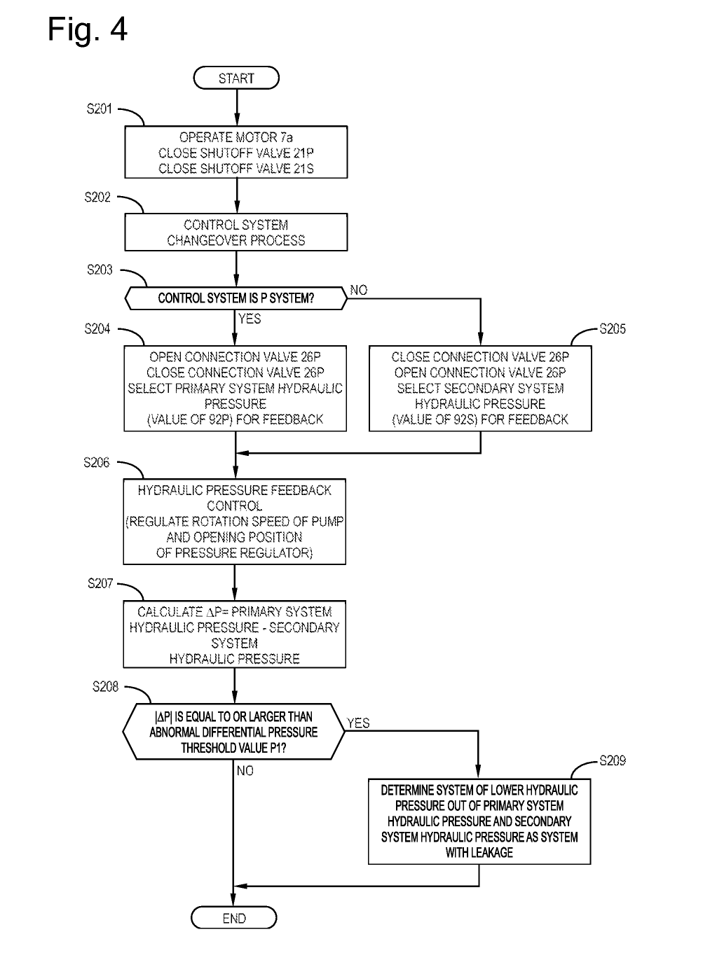

FIG. 4 is a flowchart showing a flow of the first fluid leakage detection process.

At step S201, the first fluid leakage detector 107 operates the motor 7a and closes the shutoff valves 21P and 21S.

At step S202, the first fluid leakage detector 107 performs a control system changeover process. The control system changeover process selectively changes over between control in the P system and control in the S system. According to embodiment 1, this changeover is performed at predetermined time intervals (for example, 150 ms).

At step S203, the first fluid leakage detector 107 determines whether the P system is selected as the current control system. In the case of YES, the flow proceeds to step S204. In the case of NO, the flow proceeds to step S205.

At step S204, the first fluid leakage detector 107 opens the connection valve 26P, closes the connection valve 26S, and sets a feedback hydraulic pressure for wheel cylinder hydraulic pressure control to a value set by the primary system hydraulic pressure sensor 92P.

At step S205, the first fluid leakage detector 107 closes the connection valve 26P, opens the connection valve 26S and sets the feedback hydraulic pressure for wheel cylinder hydraulic pressure control to a value detected by the secondary system hydraulic pressure sensor 92S.

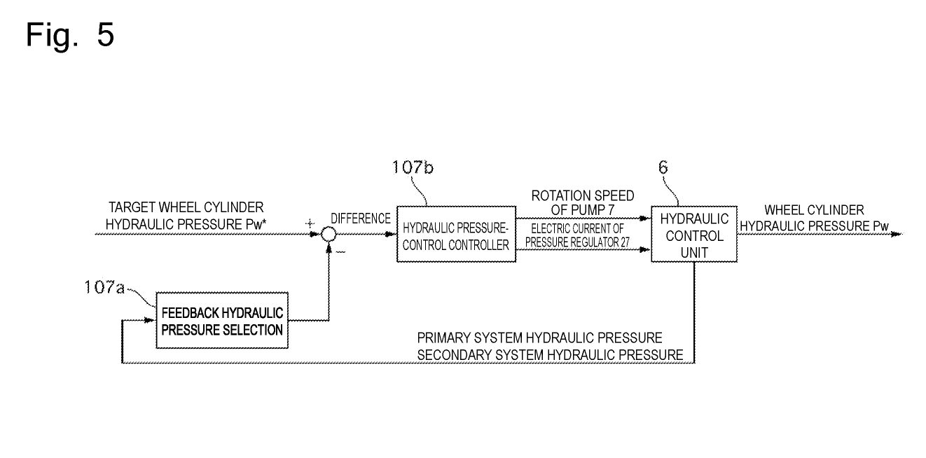

At step S206, the first fluid leakage detector 107 performs hydraulic pressure feedback control by servo control such that wheel cylinder hydraulic pressure in the control system becomes equal to the target wheel cylinder hydraulic pressure Pw* by regulating the rotation speed of the pump 7 and the opening position of the pressure regulator 27. FIG. 5 is a block diagram of the hydraulic pressure feedback control configured such that a feedback hydraulic pressure becomes equal to the target wheel cylinder hydraulic pressure Pw*. The feedback hydraulic pressure selected by a feedback hydraulic pressure selector 107a is the hydraulic pressure in the system with the connection valve (26P or 26S) opened (processing of either S204 or S205). This is because the wheel cylinder hydraulic pressure is adjustable by the pump 7 and the pressure regulator 27 only in the system with the connection valve opened. In a non-adjustable system, the shutoff valve 21 and the connection valve 26 are both closed, so that a closed circuit is formed to maintain the wheel cylinder hydraulic pressure. A hydraulic pressure difference between the target wheel cylinder hydraulic pressure Pw* and the feedback hydraulic pressure is input into a hydraulic pressure-control controller 107b. The hydraulic pressure-control controller 107b controls the rotation speed of the pump 7 and the electric current (opening position) of the pressure regulator 27 with a view to eliminating the hydraulic pressure difference. This operates the hydraulic control unit 6 to output the wheel cylinder hydraulic pressure Pw.

At step S207, the first fluid leakage detector 107 calculates a differential pressure ΔP between the hydraulic pressures in the respective systems under control by hydraulic pressure feedback (the value of the primary system hydraulic pressure sensor 92P and the value of the secondary system hydraulic pressure sensor 92S).

At step S208, the first fluid leakage detector 107 determines whether an absolute value |ΔP| of the differential pressure ΔP is equal to or larger than a predetermined abnormal differential pressure threshold value P1. In the case of YES, the flow proceeds to step S209. In the case of NO, the flow terminates the processing.

At step S209, the first fluid leakage detector 107 determines that the system of the lower hydraulic pressure out of the P system and the S system is a defective system.

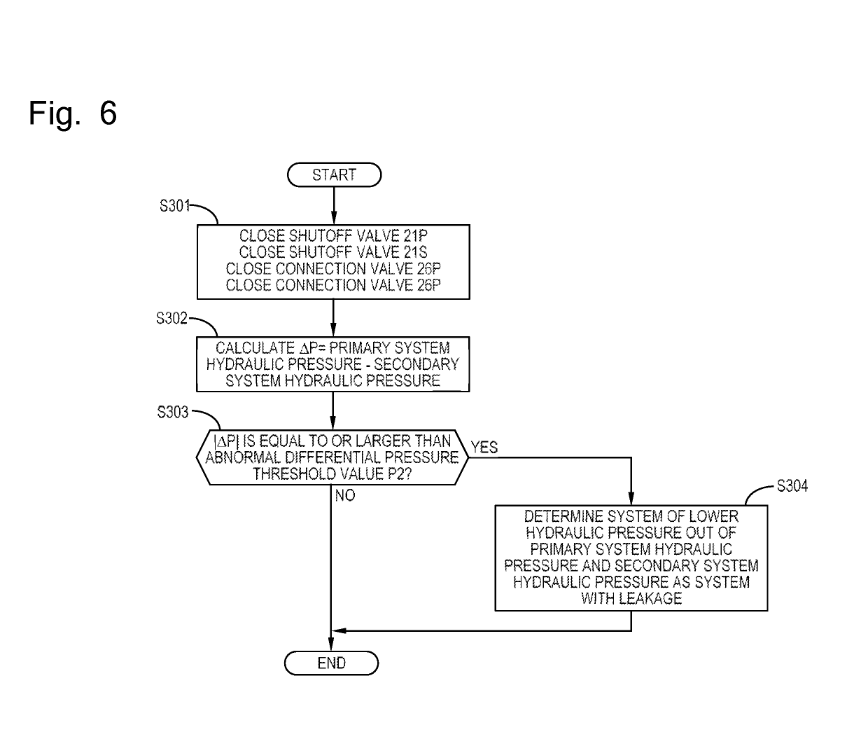

FIG. 6 is a flowchart showing a flow of the second fluid leakage detection process.

At step S301, the second fluid leakage detector 108 closes the shutoff valves 21P and 21S and the connection valves 26P and 26S. This forms a closed circuit of the fluid paths 11B (11P), 11a and 11d and the wheel cylinders 8a and 8d in the P system and enables the hydraulic pressure in the P system to be maintained in the case of no fluid leakage. Similarly, this forms a closed circuit of the fluid paths 11B (11S), 11b and 11c and the wheel cylinders 8b and 8c in the S system and enables the hydraulic pressure in the S system to be maintained in the case of no fluid leakage. When a fluid leakage occurs, the hydraulic pressure in the system is reduced.

At step S302, the second fluid leakage detector 108 calculates a differential pressure ΔP between the hydraulic pressures in the respective systems (the value of the primary system hydraulic pressure sensor 92P and the value of the secondary system hydraulic pressure sensor 92S).

At step S303, the second fluid leakage detector 108 determines whether an absolute value |ΔP| of the differential pressure ΔP is equal to or larger than a predetermined abnormal differential pressure threshold value P2. In the case of YES, the flow proceeds to step S304. In the case of NO, the flow terminates the processing.

At step S304, the second fluid leakage detector 108 determines that the system of the lower hydraulic pressure out of the P system and the S system is a defective system.

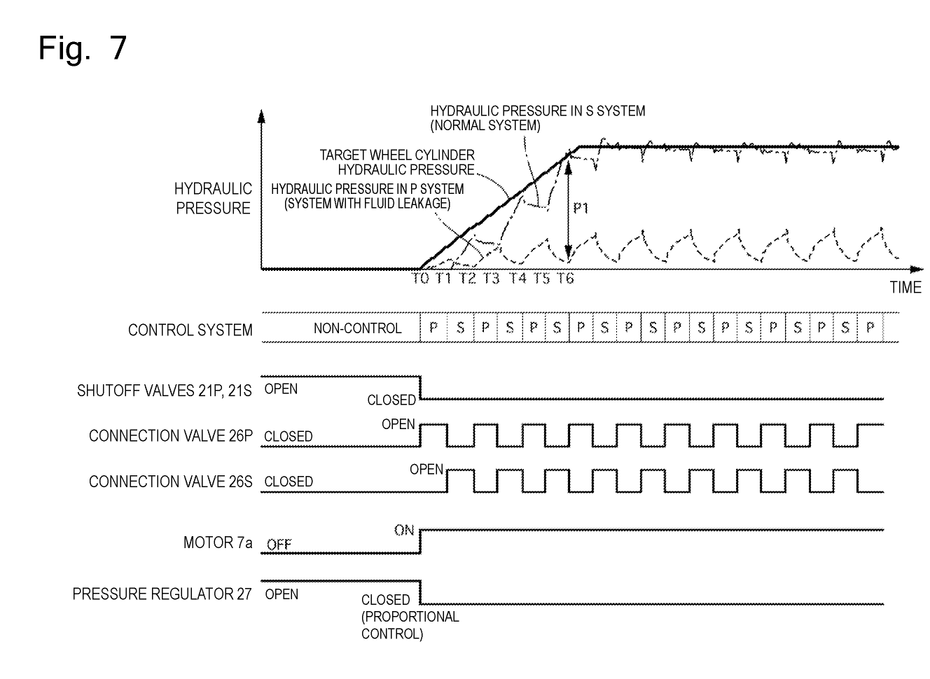

FIG. 7 is a time chart showing the operations of the hydraulic control unit 6 when only the first fluid leakage detection process is performed in the fluid leakage detection mode in the case of a relatively large amount of fluid leakage occurring in the P system (in the case where a fluid leaked part has a large opening area).

Before a time T0, the target wheel cylinder hydraulic pressure is zero. This indicates non-control state. The shutoff valves 21P and 21S are opened, the connection valves 26P and 26S are closed, the motor 7a is OFF (not operated), and the pressure regulator 27 is opened. At the time T0, the target wheel cylinder hydraulic pressure is generated, and the hydraulic pressure control is started. At the same time, the shutoff valves 21P and 21S are closed, the motor 7a is ON (operated), and the pressure regulator 27 is closed (proportional control). In an interval T0-T1, the P system is selected as the control system (determined by the control system changeover process at S202). During the interval T0-T1, the connection valve 26P in the P system is opened, and the connection valve 26S in the S system is closed. The hydraulic pressure feedback control in the interval T0-T1 performs servo control such that the value detected by the primary system hydraulic pressure sensor 92P becomes equal to the target wheel cylinder hydraulic pressure Pw*. Accordingly, in the interval T0-T1, the hydraulic pressure increases in the P system, whereas the hydraulic pressure is kept zero in the S system since a closed circuit is formed by closing both the shutoff valve 21S and the connection valve 26S. The increase in hydraulic pressure in the P system having the fluid leakage is attributed to a loss by the flow of the brake fluid. The generated hydraulic pressure is approximated to be inversely proportional to the square of the opening area of an outflow part and to be proportional to the square of the flow rate from the hydraulic pressure source (pump 7), due to the characteristics of the fluid. There is, however, a limited flow rate of the brake fluid supplied from the pump 7. When a large amount of leakage occurs, no large hydraulic pressure is generated.

In an interval T1-T2, the control system is changed over to the S system. In the interval T1-T2, the connection valve 26S in the S system is opened, and the connection valve 26P in the P system is closed. The hydraulic pressure feedback control in the interval T1-T2 performs servo control such that the value detected by the secondary system hydraulic pressure sensor 92S becomes equal to the target wheel cylinder hydraulic pressure Pw*. Accordingly, in the interval T1-T2, the hydraulic pressure increases in the S system, whereas the hydraulic pressure is expected to be maintained in the P system since a closed circuit is formed by closing both the shutoff valve 21P and the connection valve 26P. There is, however, a fluid leakage in the P system. Thus, in the interval T1-T2, the brake fluid flows outside, and the hydraulic pressure is decreased. Similarly, in an interval T2-T3, the control system is changed over to the P system. The hydraulic pressure is increased in the P system, while being maintained in the S system. In an interval T3-T4, the control system is changed over to the S system. The hydraulic pressure is increased in the S system, while being decreased in the P system, due to the effect of the fluid leakage. Repeating this series of operations gradually increases the differential pressure ΔP between the hydraulic pressure in the P system and the hydraulic pressure in the S system. At around a time T6, ΔP reaches the abnormal differential pressure threshold value P1, and a hydraulic pressure defect in the P system is detected.

As described above, the first fluid leakage detection process alternately changes over between the P system and the S system to repeat increasing the hydraulic pressure and maintaining the hydraulic pressure. This detects the system with fluid leakage, while enabling the hydraulic pressure to be stably generated in the normal system.

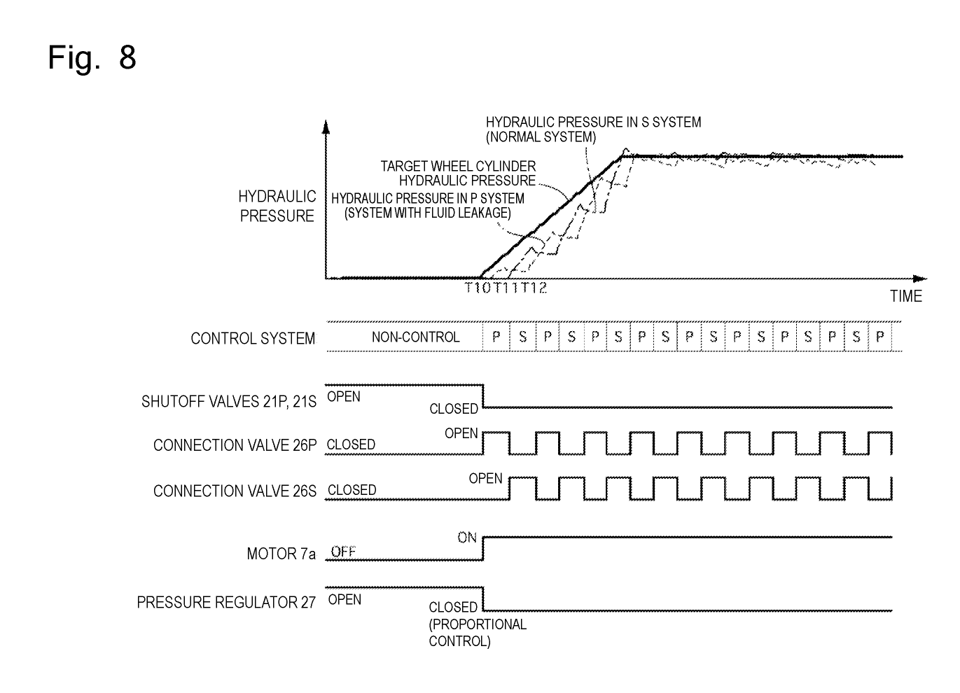

FIG. 8 is a time chart showing the operations of the hydraulic control unit 6 when only the first fluid leakage detection process is performed in the fluid leakage detection mode in the case of a relatively small amount of fluid leakage occurring in the P system (in the case where a fluid leaked part has a small opening area).

Before a time T10, the target wheel cylinder hydraulic pressure Pw* is zero. This indicates non-control state. At the time T10, the target wheel cylinder hydraulic pressure Pw* is generated, and the hydraulic pressure control is started. In an interval T10-T11, the P system is selected as the control system, and the hydraulic pressure is increased in the P system while being maintained in the S system. In an interval T11-T12, the S system is selected as the control system, and the hydraulic pressure is increased in the S system while being maintained in the P system. Although there is a leakage occurring in the P system, the leakage is a relatively small amount. There is accordingly no significant decrease in the hydraulic pressure in the course of operation of maintaining the hydraulic pressure in the P system. Similarly, during control of the hydraulic pressure with changeover of the control system after a time T12, both the P system and the S system behave as if the hydraulic pressure is increased and is maintained. In the case of a relatively small amount of leakage, no significant change in hydraulic pressure such as to check the adverse effect on the controllability of the system with fluid leakage is likely to occur. With a view to solving this problem, one possible measure lengthens the changeover period of the control system and increases the effect of pressure reduction in the system with fluid leakage, so as to increase the differential pressure ΔP between the P system and the S system. This technique of lengthening the control interval is, however, likely to cause a large left-right differential pressure in the case of a change in the target wheel cylinder hydraulic pressure. This is likely to cause the poor detection performance of the differential pressure ΔP and unstable vehicle behaviors.

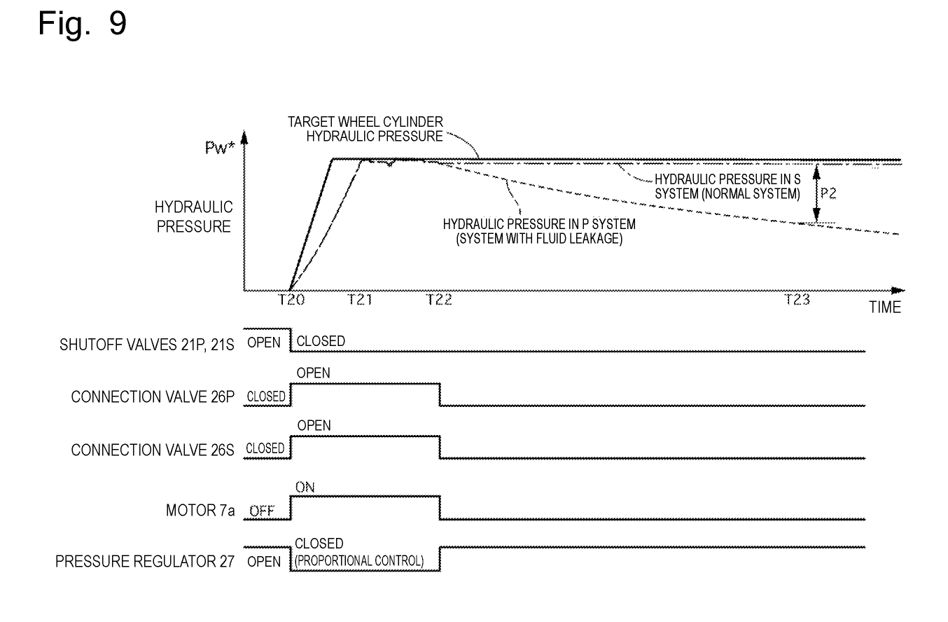

FIG. 9 is a time chart showing the operations of the hydraulic control unit 6 when only the second fluid leakage detection process is performed in the fluid leakage detection mode in the case of a relatively small amount of fluid leakage occurring in the P system.

Before a time T20, the target wheel cylinder hydraulic pressure Pw* is zero. This indicates non-control state. At the time T20, the target wheel cylinder hydraulic pressure Pw* is generated, and the hydraulic pressure control is started. The shutoff valves 21P and 21S are closed, the connection valves 26P and 26S are opened, the motor 7a is ON, and the pressure regulator 27 is closed (proportional control). Although there is a leakage of the wheel cylinder 8, the leakage is a relatively small amount. The hydraulic pressure control can thus be performed without difficulty. At a time T21, the hydraulic pressures in both the P system and the S system reach the target wheel cylinder hydraulic pressure. In an interval T21-T22, it is determined whether the wheel cylinder hydraulic pressure reaches the target wheel cylinder hydraulic pressure, according to relationships of the hydraulic pressures in the respective systems to the target wheel cylinder hydraulic pressure. At a time T22, the second fluid leakage detection process is started. The shutoff valves 21P and 21S are closed, the connection valves 26P and 26S are closed, the motor 7a is OFF, and the pressure regulator 27 is opened. In this state, the motor 7a may not be necessarily stopped. Similarly, the pressure regulator 27 may not be necessarily opened. After the time T22, closed circuits are formed respectively in the P system and in the S system. The hydraulic pressure is subsequently maintained in the S system with no fluid leakage while being gradually decreased in the P system with a relatively small amount of fluid leakage. At a time T23, the absolute value |ΔP| of the differential pressure ΔP between the value detected by the primary system hydraulic pressure sensor 92P and the value detected by the secondary system hydraulic pressure sensor 92S reaches the abnormal differential pressure threshold value P2, and a hydraulic pressure defect in the P system is detected.

As described above, the second fluid leakage detection process performs the operations of maintaining the hydraulic pressure independently in the P system and in the S system. This enables a relatively small amount of fluid leakage to be detected. During the second fluid leakage detection process, however, both the P system and the S system are completely separated from the pump 7 and the pressure regulator 27. The second fluid leakage detection process accordingly cannot follow a change in the target wheel cylinder hydraulic pressure. It is accordingly preferable to perform the second fluid leakage detection process in the situation that the target wheel cylinder hydraulic pressure is kept constant, for example, at the time of vehicle stop.

As shown in FIG. 9, the second fluid leakage detection process is on the premise that predetermined hydraulic pressure is generated in both the P system and the S system for the purpose of detection of a fluid leakage. In the case of a relatively large amount of leakage, however, there may be a failure in generating the hydraulic pressure in both the P system and the S system. This may cause a failure in satisfying the condition for performing the fluid leakage detection. Maintaining the wheel cylinder 8 at a higher hydraulic pressure prior to detection of a fluid leakage increases the outflow rate and thereby improves the detection performance for a relatively small amount of fluid leakage. The low hydraulic pressure of the wheel cylinder 8 decreases the outflow rate and requires a long time period for detection. The higher maintained hydraulic pressure is accordingly preferable. In the case of a fluid leakage, however, the higher maintained hydraulic pressure reduces the possibility that the hydraulic pressure is generated. One possible measure for generating the hydraulic pressure is to increase the flow rate of the pump 7. This technique, however, consumes the brake fluid remaining in the reservoir tank 4 quickly and is undesirable from the safety point of view.

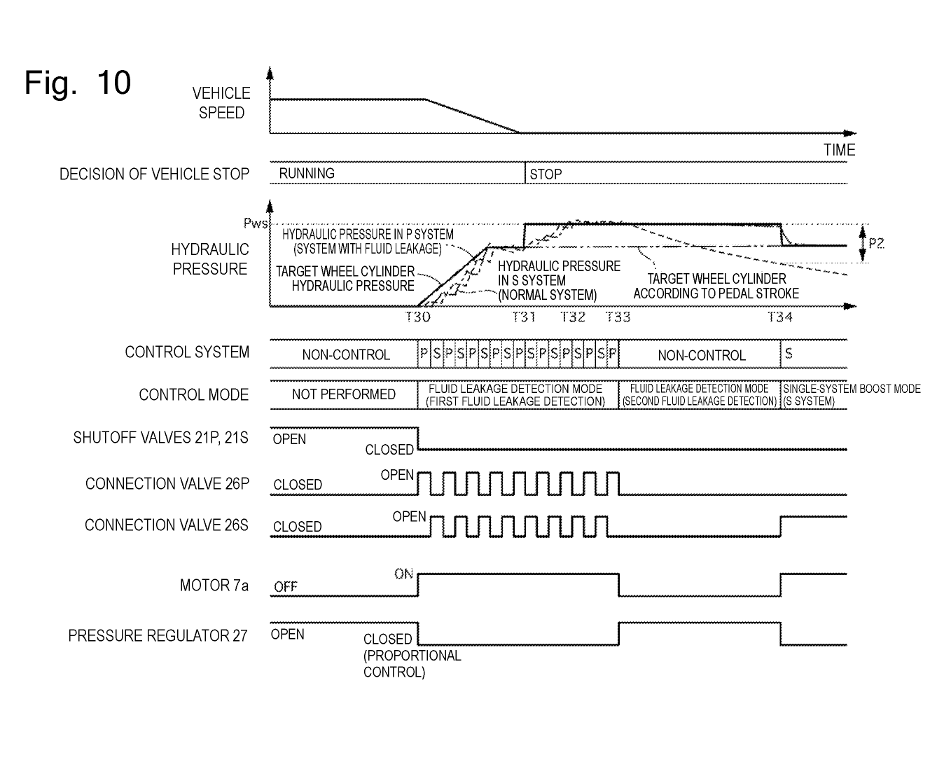

FIG. 10 is a time chart showing operations of the hydraulic control unit 6 in the fluid leakage detection mode according to embodiment 1 in the case of a relatively small amount of fluid leakage occurring in the P system.

At a time T30 when the vehicle is running, a braking request is given, the target wheel cylinder hydraulic pressure is set according to the pedal stroke S, and the first fluid leakage detection process is started. The amount of fluid leakage is a relatively small amount. Wheel cylinder hydraulic pressures are thus generated in both the P system and the S system according to the target wheel cylinder hydraulic pressure, and the vehicle is decelerated. At a time T31, the vehicle stops, and the target wheel cylinder hydraulic pressure is set to the predetermined hydraulic pressure Pws for detection of fluid leakage at vehicle stop. This is set to be higher than the target wheel cylinder hydraulic pressure according to the driver's brake operation. Increasing the hydraulic pressure aims to increase the flow rate of leakage and enhance the detection performance. If the amount of fluid leakage is a relatively large amount, a significant differential pressure is generated between the hydraulic pressures in the P system and in the S system when the first fluid leakage detection process is performed. The system with fluid leakage can thus be determined by only the first fluid leakage detection process (operation like FIG. 7). In the case of FIG. 10, on the other hand, the amount of fluid leakage is a relatively small amount. At a time T32, the hydraulic pressures in both the P system and the S system reach the predetermined hydraulic pressure Pws. In an interval T32-T33, the hydraulic pressures in both the P system and the S system are maintained at the predetermined hydraulic pressure Pws, so that the operation of the second fluid leakage detection process is started.

At a time T34, the differential pressure between the P system and the S system exceeds the abnormal differential pressure threshold value P2, so that the P system having the lower hydraulic pressure than the S system is determined as the system with fluid leakage. The hydraulic pressure control is shifted to the single-system boost mode of the S system, and the target wheel cylinder hydraulic pressure is changed over to a target wheel cylinder hydraulic pressure according to the pedal stroke S. The hydraulic pressure in the P system is continuously maintained. In response to termination of the driver's brake operation, however, the hydraulic pressure in the P system is decreased by, for example, opening the shutoff valve 21P in the P system.

As described above, when lowering of the fluid level in the reservoir tank 4 is detected, the fluid leakage detection mode according to embodiment 1 first performs the first fluid leakage detection process and subsequently performs the second fluid leakage detection process. There is a need to increase the hydraulic pressures in both the P system and the S system to the predetermined hydraulic pressure Pws, in order to perform the second fluid leakage detection process. When there is a relatively small amount of leakage of the brake fluid, performing the first fluid leakage detection process prior the second fluid leakage detection process surely increases the hydraulic pressures in both the P system and the S system to the predetermined hydraulic pressure Pws, and thus the second fluid leakage detection process can detect the system with fluid leakage. When there is a relatively large amount of leakage of the brake fluid, on the other hand, the first fluid leakage detection process can detect the system with fluid leakage. Accordingly, in the fluid leakage detection mode according to embodiment 1, specifying the execution procedure of the first fluid leakage detection process and the second fluid leakage detection process enhances the detection accuracy of the system with fluid leakage, regardless of the amount of leakage of the brake fluid.

The first fluid leakage detection process is performed when the fluid level of the brake fluid stored in the reservoir tank 4 becomes lower than a predetermined level. When a fluid leakage defect occurs in the wheel cylinder 8, the fluid level in the reservoir tank 4 is lowered. Monitoring the fluid level thus enables the fluid leakage detection process to be started promptly.

The second fluid leakage detection process is performed after it is determined that the vehicle is at stop. During the second fluid leakage detection process, the connection valves 26P and 26S are closed to separate both the P system and the S system from the pump 7 and the pressure regulator 27. The second fluid leakage detection process accordingly cannot follow a change in the target wheel cylinder hydraulic pressure. When the vehicle is at stop, on the other hand, the target wheel cylinder hydraulic pressure can be kept constant. There is accordingly no driver's unintentional vehicle behavior (change in deceleration) even if the second fluid leakage detection process is performed.

When the execution time of the second fluid leakage detection process exceeds the predetermined time period, it is determined that lowering of the fluid level in the reservoir tank 4 is attributed to a reason other than the fluid leakage defect of the wheel cylinder 8. A failure in detecting the system with fluid leakage in a certain time period in the second fluid leakage detection process means that there is no fluid leakage of the wheel cylinder 8. In this case, terminating the second fluid leakage detection process suppresses the detection time of the system with fluid leakage from being unnecessarily increased.

The first fluid leakage detection process is performed when it is determined that a braking request is given during running of the vehicle. The first fluid leakage detection process alternately changes over between the P system and the S system and repeats increasing the hydraulic pressure and maintaining the hydraulic pressure. This detects the system with fluid leakage, while causing the normal system to generate a braking force corresponding to the braking request even during running of the vehicle.

The first fluid leakage detection process alternately open and closes the connection valve 26P in the P system and the connection valve 26S in the S system at predetermined cycles a plurality of times. This ensures a stable increase in braking force.

### Embodiment 2

A brake device according to embodiment 2 has a basic configuration similar to that of embodiment 1. Only differences from embodiment 1 are described below.

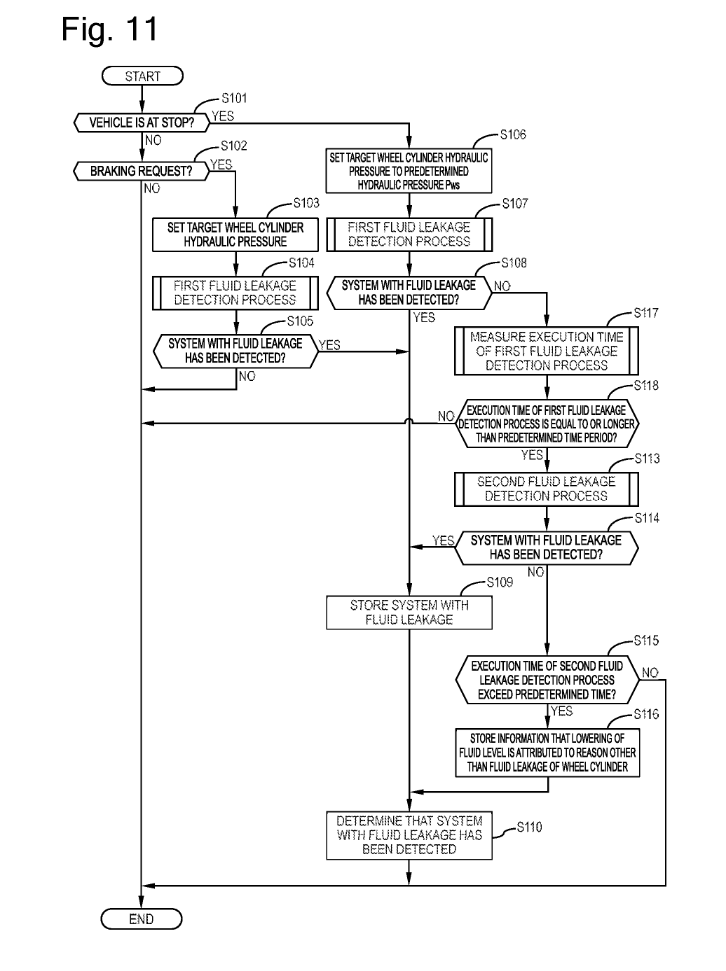

FIG. 11 is a flowchart showing a processing flow in a fluid leakage detection mode according to embodiment 2. The failsafe portion 103 of the ECU 100 includes a first fluid leakage detection execution time determiner 113 as the configuration to perform the fluid leakage detection mode.

At step S117, the first fluid leakage detection execution time determiner 113 measures an execution time of the first fluid leakage detection process.

At step S118, the first fluid leakage detection execution time determiner 113 determines whether the execution time of the first fluid leakage detection process is equal to or longer than a predetermined time period. In the case of YES, the flow proceeds to step S113. In the case of NO, the flow terminates the processing. Step S118 is the first fluid leakage detection execution time determination step.

A failure in detecting the system with fluid leakage in a certain time period in the first fluid leakage detection process indicates a relatively small amount of leakage of the brake fluid. In this case, shifting from the first fluid leakage detection process to the second fluid leakage detection process suppresses the detection time of the system with fluid leakage from being unnecessarily increased.

### Other Embodiments

The foregoing describes the embodiments for implementing the present invention. The specific configuration of the present invention is, however, not limited to the configurations of the embodiments. Changes of design and the like within the spirit of the present invention are included in the present invention.

The hydraulic pressure source is configured by only the pump 7 in the above description. A pressure accumulating device such as an accumulator may be used in combination with the pump 7. The hydraulic control unit may be an integral type configured by integrating the master cylinder 3, the hydraulic control unit 6 and the stroke simulator 5 or may be configured by a plurality of more divisional units.

The condition of step S1 in FIG. 2, i.e., the condition for the shift to the operation for detection of the defective system may be any condition that indicates a possibility of fluid leakage defect. For example, a condition that a difference between the target wheel cylinder hydraulic pressure and the actual wheel cylinder hydraulic pressure becomes equal to or larger than a predetermined value may be employed as the condition for the shift to the operation for detection of the defective system.

The detection of the defective system in the first fluid leakage detection process is not limited to the processing of S207 to S209 shown in FIG. 4. For example, differential pressures between the hydraulic pressures in the respective systems and the target wheel cylinder hydraulic pressure Pw* may be monitored. The defective system may be determined when the state that the absolute value |ΔP| of the differential pressure ΔP exceeds the abnormal differential pressure threshold value P1 continues for a certain time period. The defective system may be determined when an integral value of the differential pressure ΔP exceeds a predetermined value. A variety of techniques may be applied to evaluate the differential pressure ΔP.

The detection of the defective system in the second fluid leakage detection process is not limited to the processing of S301 to S304 shown in FIG. 5. For example, the pressure at the timing when the brake fluid is sealed at S301 may be stored, and a differential pressure from the stored pressure may be monitored. The defective system may be determined when the state that the differential pressure exceeds the abnormal differential pressure threshold value P2 continues for a certain time period. The defective system may be determined when an integral value of the differential pressure ΔP exceeds a predetermined value. A variety of techniques may be applied to evaluate the differential pressure ΔP.

At S202 in FIG. 4, the changeover time of the control system during stop of the vehicle may be set to be longer than the changeover time during running of the vehicle. Increasing the changeover time during running of the vehicle increases an amount of one pressure increase or an amount of one pressure decrease. This generates a large differential pressure between the P system and the S system and is likely to affect the vehicle behavior. Generation of the differential pressure between the P system and the S system during stop of the vehicle, on the other hand, does not affect the vehicle behavior and ensures early detection of the system with fluid leakage.

The following describes aspects figured out from the embodiments described above.

According to one aspect, a brake device includes a hydraulic unit and a control unit. The hydraulic unit includes a primary system connection fluid path connected to a wheel cylinder in a primary system configured to apply a braking force to a wheel according to a brake hydraulic pressure; a secondary system connection fluid path connected to a wheel cylinder in a secondary system configured to apply a braking force to a wheel according to the brake hydraulic pressure; a connecting fluid path connecting the primary system connection fluid path with the secondary system connection fluid path; a primary system connection valve provided in the connecting fluid path and configured to restrict a flow of a brake fluid to the primary system connection fluid path; a secondary system connection valve provided in the connecting fluid path and configured to restrict a flow of the brake fluid to the secondary system connection fluid path; a hydraulic pressure source configured to discharge the brake fluid to a portion in the connecting fluid path between the primary system connection valve and the secondary system connection valve; a primary system hydraulic pressure sensor provided in a fluid path in the primary system; and a secondary system hydraulic pressure sensor provided in a fluid path in the secondary system. The control unit includes a hydraulic pressure controller configured to control operations of the primary system connection valve, the secondary system connection valve and the hydraulic pressure source; a first fluid leakage detector configured to detect a fluid leakage of the brake fluid occurring in each of the primary system and the secondary system, based on a primary system hydraulic pressure and a secondary system hydraulic pressure respectively detected by the primary system hydraulic pressure sensor and the secondary system hydraulic pressure sensor in a state that the hydraulic pressure source is driven by the hydraulic pressure controller and that the primary system connection valve and the secondary system connection valve are alternately opened and closed; and a second fluid leakage detector configured to detect a fluid leakage of the brake fluid occurring in each of the primary system and the secondary system, based on the primary system hydraulic pressure and the secondary system hydraulic pressure respectively detected by the primary system hydraulic pressure sensor and the secondary system hydraulic pressure sensor in a state that the primary system connection valve and the secondary system connection valve are closed by the hydraulic pressure controller after execution of the fluid leakage detection by the first fluid leakage detector.

According to a more preferable aspect, in the above aspect, the control unit includes a two-systems hydraulic pressure generation/non-generation determiner configured to determine whether the primary system hydraulic pressure and the secondary system hydraulic pressure respectively detected by the primary system hydraulic pressure sensor and the secondary system hydraulic pressure sensor reach a predetermined target hydraulic pressure for fluid leakage detection, in the fluid leakage detection performed by the first fluid leakage detector. When the two-systems hydraulic pressure generation/non-generation determiner determines that the hydraulic pressures of the brake fluid in both the primary system and the secondary system reach the target hydraulic pressure for fluid leakage detection, the control unit causes the second fluid leakage detector to perform the fluid leakage detection.

According to another preferable aspect, in any of the above aspects, the control unit includes a vehicle drive/stop state determiner configured to determine a drive/stop state of a vehicle. When the vehicle drive/stop state determiner determines that the vehicle is at stop, the control unit causes the second fluid leakage detector to perform the fluid leakage detection.

According to another preferable aspect, in any of the above aspects, the control unit includes a second fluid leakage detection execution time determiner configured to determine whether a time period of fluid leakage detection reaches a predetermined second fluid leakage detection execution time, in a state that a fluid leakage is not determined by the fluid leakage detection performed by the second fluid leakage detector. When the second fluid leakage detection execution time determiner determines that the time period of fluid leakage detection reaches the second fluid leakage detection execution time, the control unit determines that no fluid leakage of the brake fluid occurs in each of the primary system and the secondary system.

According to another preferable aspect, in any of the above aspects, the control unit includes a target wheel cylinder hydraulic pressure calculator configured to calculate a target wheel cylinder hydraulic pressure according to a brake pedal operation. The target hydraulic pressure for fluid leakage detection is higher than the target wheel cylinder hydraulic pressure calculated by the target wheel cylinder hydraulic pressure calculator.

According to another preferable aspect, in any of the above aspects, the control unit includes a first fluid leakage detection execution time determiner configured to determine whether a time period of fluid leakage detection reaches a predetermined first fluid leakage detection execution time, in a state that a fluid leakage is not determined by the fluid leakage detection performed by the first fluid leakage detector. When the first fluid leakage detection execution time determiner determines that the time period of fluid leakage detection reaches the first fluid leakage detection execution time, the control unit causes the second fluid leakage detector to perform the fluid leakage detection.

According to another preferable aspect, in any of the above aspects, the control unit includes a vehicle drive/stop state determiner configured to determine a drive/stop state of a vehicle. When the vehicle drive/stop state determiner determines that the vehicle is at stop, the control unit causes the second fluid leakage detector to perform the fluid leakage detection.

According to another preferable aspect, in any of the above aspects, the control unit includes a vehicle braking request determiner configured to determine whether a braking request is given to the vehicle, when the vehicle drive/stop state determiner determines that the vehicle is running. When the vehicle braking request determiner determines that the braking request is given to the vehicle, the control unit causes the first fluid leakage detector to perform the fluid leakage detection.

According to another preferable aspect, in any of the above aspects, one end of the primary system connection fluid path is connected to a first chamber of a master cylinder configured to generate a brake hydraulic pressure in response to a brake pedal operation, and one end of the secondary system connection fluid path is connected to a second chamber of the master cylinder.

According to another preferable aspect, in any of the above aspects, the fluid pressure controller closes the primary system connection valve when a fluid leakage in the primary system is detected by the first fluid leakage detector or the second fluid leakage detector, and closes the secondary system connection valve when a fluid leakage in the secondary system is detected.

According to another preferable aspect, in any of the above aspects, the first fluid leakage detector causes the hydraulic pressure controller to alternately open and close the primary system connection valve and the secondary system connection valve at predetermined cycles a plurality of times.

According to another preferable aspect, in any of the above aspects, the brake device further includes a reservoir connected to the hydraulic pressure source and configured to store the brake fluid therein. The control unit includes a fluid level detector provided in the reservoir and configured to detect a fluid level of the brake fluid. When the fluid level detected by the fluid level detector is lower than a predetermined level, the control unit causes the first fluid leakage detector to perform the fluid leakage detection.

From another view point, in one aspect, a fluid leakage detection method of a brake device includes a step of providing the brake device. The brake device includes: a primary system connection fluid path connected to a wheel cylinder in a primary system that is configured to apply a braking force to a wheel according to a brake hydraulic pressure; a secondary system connection fluid path connected to a wheel cylinder in a secondary system that is configured to apply a braking force to a wheel according to the brake hydraulic pressure; a connecting fluid path connecting the primary system connection fluid path with the secondary system connection fluid path; a primary system connection valve provided in the connecting fluid path and configured to restrict a flow of a brake fluid to the primary system connection fluid path; a secondary system connection valve provided in the connecting fluid path and configured to restrict a flow of the brake fluid to the secondary system connection fluid path; a hydraulic pressure source configured to discharge the brake fluid to a portion in the connecting fluid path between the primary system connection valve and the secondary system connection valve; a primary system hydraulic pressure sensor provided in a fluid path in the primary system; and a secondary system hydraulic pressure sensor provided in a fluid path in the secondary system. The method further includes a first fluid leakage detection step of detecting a fluid leakage of the brake fluid occurring in each of the primary system and the secondary system, based on a primary system hydraulic pressure and a secondary system hydraulic pressure respectively detected by the primary system hydraulic pressure sensor and the secondary system hydraulic pressure sensor, in a state that the hydraulic pressure source is driven and that the primary system connection valve and the secondary system connection valve are alternately opened and closed; and a second fluid leakage detection step of detecting a fluid leakage of the brake fluid occurring in each of the primary system and the secondary system, based on the primary system hydraulic pressure and the secondary system hydraulic pressure respectively detected by the primary system hydraulic pressure sensor and the secondary system hydraulic pressure sensor, in a state that the primary system connection valve and the secondary system connection valve are closed after execution of the fluid leakage detection by the first fluid leakage detection step.

Preferably, in the above aspect, the method further includes a two-systems hydraulic pressure generation/non-generation determining step of determining whether the primary system hydraulic pressure and the secondary system hydraulic pressure respectively detected by the primary system hydraulic pressure sensor and the secondary system hydraulic pressure sensor reach a predetermined target hydraulic pressure for fluid leakage detection, in the fluid leakage detection performed in the first fluid leakage detection step. When the two-systems hydraulic pressure generation/non-generation determining step determines that the hydraulic pressures of the brake fluid in both the primary system and the secondary system reach the target hydraulic pressure for fluid leakage detection, the fluid leakage detection is performed by the second fluid leakage detection step.

According to another preferable aspect, in any of the above aspects, the method further includes a vehicle drive/stop state determining step of determining a drive/stop state of a vehicle. When the vehicle drive/stop state determining step determines that the vehicle is at stop, the fluid leakage detection is performed by the second fluid leakage detection step.

According to another preferable aspect, in any of the above aspects, the method further includes a second fluid leakage detection execution time determining step of determining whether a time period of fluid leakage detection reaches a predetermined second fluid leakage detection execution time, in a state that a fluid leakage is not determined by the fluid leakage detection performed in the second fluid leakage detection step. When the second fluid leakage detection execution time determining step determines that the time period of fluid leakage detection reaches the second fluid leakage detection execution time, it is determined that no fluid leakage of the brake fluid occurs in each of the primary system and the secondary system.

According to another preferable aspect, in any of the above aspects, the method further includes a first fluid leakage detection execution time determining step of determining whether a time period of fluid leakage detection reaches a predetermined first fluid leakage detection execution time, in a state that a fluid leakage is not determined by the fluid leakage detection performed in the first fluid leakage detection step. When the first fluid leakage detection execution time determining step determines that the time period of fluid leakage detection reaches the first fluid leakage detection execution time, the fluid leakage detection is performed by the second fluid leakage detection step.

According to another preferable aspect, in any of the above aspects, the method further includes a vehicle drive/stop state determining step of determining a drive/stop state of a vehicle. When the vehicle drive/stop state determining step determines that the vehicle is at stop, the fluid leakage detection is performed by the second fluid leakage detection step.

According to another preferable aspect, in any of the above aspects, the method further includes a vehicle braking request determining step of determining whether a braking request is given to the vehicle, when the vehicle drive/stop state determining step determines that the vehicle is running. When the vehicle braking request determining step determines that the braking request is given to the vehicle, the fluid leakage detection is performed by the first fluid leakage detection step.

Having described several embodiments of the present invention, the above-described embodiments of the invention are intended to facilitate understanding of the present invention, and are not intended to limit the present invention. The present invention can be modified or improved without departing from the spirit of the present invention, and includes equivalents thereof. Further, the individual components described in the claims and the specification can be arbitrarily combined or omitted within a range that allows them to remain capable of achieving at least a part of the above-described objects or producing at least a part of the above-described advantageous effects.

The present application claims priority to Japanese patent application No. 2016-131823 filed on Jul. 1, 2016. The entirety of the disclosure of Japanese patent application No. 2016-131823 filed on Jul. 1, 2016 including the specification, the claims, the drawings, and the abstract, is incorporated herein by reference in its entirety.

### REFERENCE SIGNS LIST

FL to RL wheels

1 brake device

2 brake pedal

3 master cylinder

4 reservoir tank (reservoir)

6 hydraulic control unit (hydraulic unit)

7 pump (hydraulic pressure source)

8a, 8d wheel cylinders (wheel cylinders in primary system)

8b, 8c wheel cylinders (wheel cylinders in secondary system)

11P first fluid path (primary system connection fluid path)

11S first fluid path (secondary system connection fluid path)

11a, 11d fluid paths (primary system connection fluid paths)

11b, 11c fluid paths (secondary system connection fluid paths)

16P fluid path (connecting fluid path)

16S fluid path (connecting fluid path)

26P P system connection valve (primary system connection valve)

26S S system connection valve (secondary system connection valve)

31P primary hydraulic chamber (first chamber)

31S secondary hydraulic chamber (second chamber)

92P primary system hydraulic pressure sensor

92S secondary system hydraulic pressure sensor

94 fluid level sensor (fluid level detector)

100 electronic control unit (control unit)

101 by-wire controller (hydraulic pressure controller)

105 target wheel cylinder hydraulic pressure calculator

107 first fluid leakage detector

108 second fluid leakage detector

109 two-systems hydraulic pressure generation/non-generation determiner

110 vehicle drive/stop state determiner

111 second fluid leakage detection execution time determiner

112 vehicle braking request determiner

113 first fluid leakage detection execution time determiner

1. A brake device comprising:
a hydraulic unit; and
a control unit,
wherein the hydraulic unit comprises:
a primary system connection fluid path connected to a wheel cylinder in a primary system that is configured to apply a braking force to a wheel according to a brake hydraulic pressure;
a secondary system connection fluid path connected to a wheel cylinder in a secondary system that is configured to apply a braking force to a wheel according to the brake hydraulic pressure;
a connecting fluid path connecting the primary system connection fluid path with the secondary system connection fluid path;
a primary system connection valve provided in the connecting fluid path and configured to restrict a flow of a brake fluid to the primary system connection fluid path;
a secondary system connection valve provided in the connecting fluid path and configured to restrict a flow of the brake fluid to the secondary system connection fluid path;
a hydraulic pressure source configured to discharge the brake fluid a portion in the connecting fluid path between the primary system connection valve and the secondary system connection valve;
a primary system hydraulic pressure sensor provided in a fluid path in the primary system; and
a secondary system hydraulic pressure sensor provided in a fluid path in the secondary system, and
the control unit comprises:
a hydraulic pressure controller configured to control operations of the primary system connection valve, the secondary system connection valve, and the hydraulic pressure source;
a first fluid leakage detector configured to detect a fluid leakage of the brake fluid occurring in each of the primary system and the secondary system, based on a primary system hydraulic pressure and a secondary system hydraulic pressure respectively detected by the primary system hydraulic pressure sensor and the secondary system hydraulic pressure sensor, in a state that the hydraulic pressure source is driven by the hydraulic pressure controller and that the primary system connection valve and the secondary system connection valve are alternately opened and closed; and
a second fluid leakage detector configured to detect a fluid leakage of the brake fluid occurring in each of the primary system and the secondary system, based on the primary system hydraulic pressure and the secondary system hydraulic pressure respectively detected by the primary system hydraulic pressure sensor and the secondary system hydraulic pressure sensor, in a state that the primary system connection valve and the secondary system connection valve are closed by the hydraulic pressure controller after execution of the fluid leakage detection by the first fluid leakage detector.

2. The brake device according to claim 1, wherein the control unit comprises a two-systems hydraulic pressure generation/non-generation determiner configured to determine whether the primary system hydraulic pressure and the secondary system hydraulic pressure respectively detected by the primary system hydraulic pressure sensor and the secondary system hydraulic pressure sensor reach a predetermined target hydraulic pressure for fluid leakage detection, in the fluid leakage detection performed by the first fluid leakage detector, and
when the two-systems hydraulic pressure generation/non-generation determiner determines that the hydraulic pressures of the brake fluid in both the primary system and the secondary system reach the target hydraulic pressure for fluid leakage detection, the control unit causes the second fluid leakage detector to perform the fluid leakage detection.

3. The brake device according to claim 2, wherein the control unit comprises a vehicle drive/stop state determiner configured to determine a drive/stop state of a vehicle, and
when the vehicle drive/stop state determiner determines that the vehicle is at stop, the control unit causes the second fluid leakage detector to perform the fluid leakage detection.

4. The brake device according to claim 3, wherein the control unit comprises a second fluid leakage detection execution time determiner configured to determine whether a time period of fluid leakage detection reaches a predetermined second fluid leakage detection execution time, in a state that a fluid leakage is not determined by the fluid leakage detection performed by the second fluid leakage detector, and
when the second fluid leakage detection execution time determiner determines that the time period of fluid leakage detection reaches the second fluid leakage detection execution time, the control unit determines that no fluid leakage of the brake fluid occurs in each of the primary system and the secondary system.

5. The brake device according to claim 3, wherein the control unit comprises a target wheel cylinder hydraulic pressure calculator configured to calculate a target wheel cylinder hydraulic pressure according to a brake pedal operation, and
the target hydraulic pressure for fluid leakage detection is higher than the target wheel cylinder hydraulic pressure calculated by the target wheel cylinder hydraulic pressure calculator.

6. The brake device according to claim 1, wherein the control unit comprises a first fluid leakage detection execution time determiner configured to determine whether a time period of fluid leakage detection reaches a predetermined first fluid leakage detection execution time, in a state that a fluid leakage is not determined by the fluid leakage detection performed by the first fluid leakage detector, and
when the first fluid leakage detection execution time determiner determines that the time period of fluid leakage detection reaches the first fluid leakage detection execution time, the control unit causes the second fluid leakage detector to perform the fluid leakage detection.

7. The brake device according to claim 1, wherein the control unit comprises a vehicle drive/stop state determiner configured to determine a drive/stop state of a vehicle, and
when the vehicle drive/stop state determiner determines that the vehicle is at stop, the control unit causes the second fluid leakage detector to perform the fluid leakage detection.

8. The brake device according to claim 7, wherein the control unit comprises a vehicle braking request determiner configured to determine whether a braking request is given to the vehicle, when the vehicle drive/stop state determiner determines that the vehicle is running, and
when the vehicle braking request determiner determines that the braking request is given to the vehicle, the control unit causes the first fluid leakage detector to perform the fluid leakage detection.

9. The brake device according to claim 1, wherein one end of the primary system connection fluid path is connected to a first chamber of a master cylinder configured to generate a brake hydraulic pressure in response to a brake pedal operation, and one end of the secondary system connection fluid path is connected to a second chamber of the master cylinder.

10. The brake device according to claim 1, wherein the fluid pressure controller closes the primary system connection valve when a fluid leakage in the primary system is detected by the first fluid leakage detector or the second fluid leakage detector, and closes the secondary system connection valve when a fluid leakage in the secondary system is detected.

11. The brake device according to claim 1, wherein the first fluid leakage detector causes the hydraulic pressure controller to alternately open and close the primary system connection valve and the secondary system connection valve at predetermined cycles a plurality of times.

12. The brake device according to claim 1, further comprising:
a reservoir connected to the hydraulic pressure source and configured to store the brake fluid therein, wherein
the control unit comprises a fluid level detector provided in the reservoir and configured to detect a fluid level of the brake fluid, and
when the fluid level detected by the fluid level detector is lower than a predetermined level, the control unit causes the first fluid leakage detector to perform the fluid leakage detection.

13. A fluid leakage detection method of a brake device, the method comprising:
a step of providing the brake device,
wherein the brake device comprises: a primary system connection fluid path connected to a wheel cylinder in a primary system that is configured to apply a braking force to a wheel according to a brake hydraulic pressure; a secondary system connection fluid path connected to a wheel cylinder in a secondary system that is configured to apply a braking force to a wheel according to the brake hydraulic pressure; a connecting fluid path connecting the primary system connection fluid path with the secondary system connection fluid path; a primary system connection valve provided in the connecting fluid path and configured to restrict a flow of a brake fluid to the primary system connection fluid path; a secondary system connection valve provided in the connecting fluid path and configured to restrict a flow of the brake fluid to the secondary system connection fluid path; a hydraulic pressure source configured to discharge the brake fluid a portion in the connecting fluid path between the primary system connection valve and the secondary system connection valve; a primary system hydraulic pressure sensor provided in a fluid path in the primary system; and a secondary system hydraulic pressure sensor provided in a fluid path in the secondary system,
the method further comprising:
a first fluid leakage detection step of detecting a fluid leakage of the brake fluid occurring in each of the primary system and the secondary system, based on a primary system hydraulic pressure and a secondary system hydraulic pressure respectively detected by the primary system hydraulic pressure sensor and the secondary system hydraulic pressure sensor, in a state that the hydraulic pressure source is driven and that the primary system connection valve and the secondary system connection valve are alternately opened and closed; and
a second fluid leakage detection step of detecting a fluid leakage of the brake fluid occurring in each of the primary system and the secondary system, based on the primary system hydraulic pressure and the secondary system hydraulic pressure respectively detected by the primary system hydraulic pressure sensor and the secondary system hydraulic pressure sensor, in a state that the primary system connection valve and the secondary system connection valve are closed after execution of the fluid leakage detection by the first fluid leakage detection step.

14. The fluid leakage detection method of the brake device according to claim 13, further comprising a two-systems hydraulic pressure generation/non-generation determining step of determining whether the primary system hydraulic pressure and the secondary system hydraulic pressure respectively detected by the primary system hydraulic pressure sensor and the secondary system hydraulic pressure sensor reach a predetermined target hydraulic pressure for fluid leakage detection, in the fluid leakage detection performed in the first fluid leakage detection step,
wherein when the two-systems hydraulic pressure generation/non-generation determining step determines that the hydraulic pressures of the brake fluid in both the primary system and the secondary system reach the target hydraulic pressure for fluid leakage detection, the fluid leakage detection is performed by the second fluid leakage detection step.

15. The fluid leakage detection method of the brake device according to claim 14, further comprising a vehicle drive/stop state determining step of determining a drive/stop state of a vehicle,
wherein when the vehicle drive/stop state determining step determines that the vehicle is at stop, the fluid leakage detection is performed by the second fluid leakage detection step.

16. The fluid leakage detection method of the brake device according to claim 15, further comprising a second fluid leakage detection execution time determining step of determining whether a time period of fluid leakage detection reaches a predetermined second fluid leakage detection execution time, in a state that a fluid leakage is not determined by the fluid leakage detection performed in the second fluid leakage detection step,
wherein when the second fluid leakage detection execution time determining step determines that the time period of fluid leakage detection reaches the second fluid leakage detection execution time, it is determined that no fluid leakage of the brake fluid occurs in each of the primary system and the secondary system.

17. The fluid leakage detection method of the brake device according to claim 13, further comprising a first fluid leakage detection execution time determining step of determining whether a time period of fluid leakage detection reaches a predetermined first fluid leakage detection execution time, in a state that a fluid leakage is not determined by the fluid leakage detection performed in the first fluid leakage detection step,
wherein when the first fluid leakage detection execution time determining step determines that the time period of fluid leakage detection reaches the first fluid leakage detection execution time, the fluid leakage detection is performed by the second fluid leakage detection step.

18. The fluid leakage detection method of the brake device according to claim 13, further comprising a vehicle drive/stop state determining step of determining a drive/stop state of a vehicle,
wherein when the vehicle drive/stop state determining step determines that the vehicle is at stop, the fluid leakage detection is performed by the second fluid leakage detection step.

19. The fluid leakage detection method of the brake device according to claim 18, further comprising a vehicle braking request determining step of determining whether a braking request is given to the vehicle, when the vehicle drive/stop state determining step determines that the vehicle is running,
wherein when the vehicle braking request determining step determines that the braking request is given to the vehicle, the fluid leakage detection is performed by the first fluid leakage detection step.
